(19) United States
(12) Patent Application Publication
(10) Pub. No.: US 2016/0185400 A1
(43) Pub. Date: Jun. 30, 2016

(54) AIRFLOW DIRECTOR IN A TEMPERATURE CONTROLLED TRANSPORT UNIT

(71) Applicant: THERMO KING CORPORATION, Minneapolis, MN (US)

(72) Inventors: Ferdy Martinus, Edina, MN (US); Robert Michael Lattin, Minneapolis, MN (US); Matthew Srnec, Minnetonka, MN (US); David J. Dykes, Eagan, MN (US); Herman H. Viegas, Bloomington, MN (US); Michael T. Nelson, Eagan, MN (US); James Joseph Wiltzius, Forest Lake, MN (US); Yahia A. Abdelhamid, La Crosse, WI (US); William O'Driscoll, Onalaska, WI (US); Wilson Samuel Jesudason Lawrence, Bangalore (IN); Abhijith Balakrishna, Bangalore (IN)

(21) Appl. No.: 14/985,684

(22) Filed: Dec. 31, 2015

Related U.S. Application Data
(60) Provisional application No. 62/098,639, filed on Dec. 31, 2014.
(60) Provisional application No. 62/098,652, filed on Dec. 31, 2014.
(60) Provisional application No. 62/098,646, filed on Dec. 31, 2014.
(60) Provisional application No. 62/098,581, filed on Dec. 31, 2014.

(51) Int. Cl. B62D 35/00; B60H 1/00; B62D 63/08; B60P 3/20; B62D 53/00

(52) U.S. Cl. CPC B62D 35/001; B60P 3/20; B62D 53/00; B62D 63/08; B60H 1/00378

(57) ABSTRACT

Embodiments to help improve an airflow using e.g., an airflow director, an aerodynamic tail, etc. for a transport unit are disclosed. Structures and methods herein are related to directing airflow to low pressure areas in relation to the transport unit which can improve energy efficiency, counter turbulent airflows, and/or reduce drag. Surface features, such as one or more openings, louvers, tunnels, baffles, air directors, deflectors, inverters, etc. are strategically arranged or positioned on the aerodynamic faring to help direct an airflow toward a transport refrigeration unit when the temperature controlled transport unit is in motion. An aerodynamic tail can direct an airflow to a relatively low pressure region at a rear end of the transport unit when the transport unit is in motion to reduce or eliminate the relatively low pressure region. The features may be stored within a storage structure attached to a rear door of the transport unit.

### FIELD

The disclosure herein relates to a transport unit. More specifically, the disclosure is directed to methods, systems and apparatuses that are configured to control airflow around the transport unit while in transport.

### BACKGROUND

A significant amount of aerodynamic drag can be created when a vehicle travels at velocities typical on a modern roadway. This can be due, in large part, to areas of low pressure that are induced on the rear surfaces of the vehicle. The low pressure can become more pronounced as airflow over the vehicle separates from the vehicle surfaces.

Vehicles having blunt rear ends can be especially affected by airflow separation starting at the abrupt transition to the rear—near a vertical surface. The low pressure that the airflow separation induces can be compounded by the relatively large area on which the low air pressure acts in comparison with more streamlined vehicles.

The low air pressure acting on the rear surfaces of a moving vehicle can produce a force that resists the forward motion of the vehicle. This force can be opposed by the vehicle's engine and requires power that is typically produced by burning fuel. Any reduction in aerodynamic drag can result in a reduction in fuel consumption.

In the current period of high fuel prices and increasing environmental consciousness, fuel efficiency improvements are a growing concern. Aerodynamic improvements are especially valuable since they can be combined with other improvements such as engine efficiency and reduced chassis weight. Increasing fuel efficiency can also provide the valuable benefit of increasing the range a given vehicle can travel between refueling.

### SUMMARY

The disclosure herein relates to a temperature controlled transport unit equipped with, for example, a transport refrigeration unit (TRU). More specifically, the disclosure is directed to methods, systems and apparatuses that are configured to help provide an airflow toward the TRU when the temperature controlled transport unit is in motion.

In some embodiments, airflow director structures, systems, apparatuses, mechanisms, and methods for a transport unit, such as for example a trailer where, in some cases for example, the trailer is temperature controlled by a transport refrigeration unit (TRU). More specifically, structures, systems, apparatuses, mechanisms, and methods related to directing airflow to low pressure areas in relation to the trailer, such as for example external to the trailer, such as toward the rear of the trailer, which can improve energy efficiency, counter turbulent airflows, and/or reduce drag are provided.

In some embodiments, an aerodynamic tail for a transport unit is provided, which can be configured to modify an aerodynamic profile of the transport unit. More specifically, systems, apparatuses and methods related to an aerodynamic tail that can be deployed by airflow are provided.

In some embodiments, a method and system for detecting, communicating and controlling the status of an aerodynamic or accessory device of a transport unit is provided.

Other features and aspects of the systems, methods, and control concepts will become apparent by consideration of the following detailed description and accompanying drawings.

### BRIEF DESCRIPTION OF THE DRAWINGS

Reference is now made to the drawings in which like reference numbers represent corresponding parts throughout.

FIG. 1 illustrates a tractor attached to a transport unit, such as for example a tractor trailer, with which the embodiments as disclosed herein can be practiced.

FIGS. 2A and 2B illustrate one embodiment of directing airflow by way of a channel extending along the transport unit.

FIGS. 3A and 3B illustrate one embodiment of directing airflow by way of a channel extending along the transport unit.

FIGS. 4A and 4B illustrate one embodiment of directing airflow by way of a channel extending along the transport unit.

FIG. 5A and 5B illustrate one embodiment of directing airflow by way of channels extending along the transport unit, such as for example implemented as cross slots in the wall structure of the transport unit.

FIG. 6 illustrate embodiments of directing airflow by way of channels extending along the transport unit, such as for example implemented as openings in the wall structure of the transport unit.

FIGS. 7A through 7D illustrate embodiments of directing airflow by way of using end structures, such as a scoop, which in some embodiments may be implemented with channels extending along the transport unit.

FIG. 8 illustrates one embodiment of directing airflow by way of a channel extending along the transport unit, and which in some embodiments, includes one or more baffles in the channel.

FIGS. 9A and 9B illustrate one embodiment of directing airflow by way of sourcing air, such as heated air from exhaust, which in some embodiments may be implemented with channels extending along the transport unit.

FIG. 10 illustrates one embodiment of directing airflow by way of an ejector, which in some embodiments may be implemented with a channel extending along the transport unit, and may source air from various locations, such as a discharge from the TRU.

FIG. 11 illustrates one embodiment of directing airflow by way of a duct, which in some embodiments may extend along the transport unit and may source air from various discharge locations of the transport unit.

FIGS. 12A through 12C illustrate embodiments of directing airflow by way of sourcing and diverting air from an area proximate the tractor trailer wheels.

FIG. 13 illustrates one embodiment of directing airflow by way of a bottom structure underneath the transport unit that in certain circumstances smoothens airflow.

FIGS. 14A through 14E illustrate embodiments of directing airflow by way of implementing relatively angled structures with respect to walls of the transport unit, such as for example louvers.

FIGS. 15A through 15E illustrate one embodiment of directing airflow by way of implementing relatively angled structures with respect to walls of the transport unit, such as for example louvers, which are shown in a non-deployed position.

FIGS. 16A through 16E illustrate the relatively angled structures with respect to walls of the transport unit as shown in FIGS. 15A to 15E, which are shown in a deployed position.

FIGS. 17A through 17E illustrate one embodiment of directing airflow by way of implementing relatively angled structures with respect to walls of the transport unit, such as for example louvers, which are shown in a non-deployed position.

FIGS. 18A through 18E illustrate the relatively angled structures with respect to walls of the transport unit as shown in FIGS. 17A to 17E, which are shown in a deployed position.

FIGS. 19A through 19D illustrate one embodiment of directing airflow by way of implementing relatively angled structures with respect to walls of the transport unit, such as for example louvers, which are shown in a non-deployed position.

FIGS. 20A through 20D illustrate the relatively angled structures with respect to walls of the transport unit as shown in FIGS. 19A to 19D, which are shown in a deployed position.

FIGS. 21A through 21D illustrate one embodiment of directing airflow by way of implementing relatively angled and/or contoured structures with respect to walls of the transport unit, such as for example baffles.

FIGS. 22A through 22E illustrate one embodiment of directing airflow by way of implementing relatively angled and/or contoured structures with respect to walls of the transport unit, such as for example fins.

FIGS. 23A through 23E illustrate embodiments of directing airflow by way of implementing relatively angled structures with respect to walls of the transport unit, such as for example awning type structures.

FIG. 24 illustrates one embodiment of directing airflow by way of implementing a mechanism or source to generate relatively high pressure air at the back of the transport unit.

FIG. 25 illustrates one embodiment of directing airflow by way of implementing a mechanism or source to generate relatively high pressure air at the back of the transport unit, such as for example a heat source such as a heating element.

FIG. 26 illustrates one embodiment of directing airflow by way of implementing a mechanism or source to generate relatively high pressure air at the back of the transport unit, such as for example a fan.

FIG. 27 illustrates one embodiment of directing airflow by way of implementing a mechanism or source to generate relatively high pressure air at the back of the transport unit, such as for example using a deflector toward the bottom of the transport unit.

FIG. 28 illustrates one embodiment of directing airflow by way of implementing a mechanism or source to generate relatively high pressure air at the back of the transport unit, such as for example a drag deflector with vanes.

FIGS. 29A and B illustrate one embodiment of directing airflow by way of implementing a mechanism or source to generate relatively high pressure air at the back of the transport unit, such as for example using one or more plates with apertures.

FIGS. 30A through 30C illustrate embodiments of directing airflow by way of implementing a mechanism or source to generate relatively high pressure air at the back of the transport unit, such as for example turbulating structures that protrude from the back of the transport unit, such as for example frames or truss type structures.

FIGS. 31A and 31B illustrate one embodiment of directing airflow by way of implementing a mechanism to vary the height of the transport unit, which can be a mechanism to assist with other airflow directing implementations.

FIGS. 32A through 32D illustrate one embodiment of directing airflow by way of implementing a power source, which can be used to assist with other airflow directing implementations, such as for example to power the other airflow directing implementations.

FIG. 33 illustrates a side view of a temperature controlled transport unit, according to one embodiment.

FIG. 34 illustrates a side view of a temperature controlled transport unit equipped with an aerodynamic faring to reduce aerodynamic drag, with which the embodiments as disclosed herein can be practiced.

FIG. 35 illustrates a side view of a temperature controlled transport unit equipped with an aerodynamic faring according to one embodiment of this disclosure.

FIG. 36 illustrates a top view of another temperature controlled transport unit equipped with an aerodynamic faring according to another embodiment of this disclosure.

FIGS. 37A to 37D illustrate different configurations of a passage configured to direct airflow in an aerodynamic faring.

FIGS. 38A and 38B illustrate another temperature controlled transport unit equipped with an aerodynamic faring according to another embodiment of this disclosure. FIG. 6A illustrates a side view of the temperature controlled transport unit. FIG. 6B illustrates a top view of the temperature controlled transport unit.

FIG. 39 illustrates an aerodynamic shell that includes adjustable sides.

FIG. 40 illustrates a side view of a transport unit, with which the embodiments as disclosed herein can be practiced.

FIGS. 41A and 41B illustrate a deployable aerodynamic tail of a transport unit tail in two different deployed states. FIG. 41A illustrates a rear perspective view of a transport unit in which the aerodynamic tail is deployed in a position that largely covers a rear end of the transport unit.

FIG. 41B illustrates a rear perspective view of a transport unit in which the aerodynamic tail is deployed in a position that does not generally cover the rear end of the transport unit.

FIG. 42 illustrates a rear perspective view of a transport unit with a deployable aerodynamic tail that includes a parachute-like structure, according to one embodiment.

FIG. 43 illustrates a rear perspective view of a transport unit with a deployable aerodynamic tail that includes a wind-sock like structure, according to another embodiment.

FIGS. 44 to 47 illustrate different embodiments of a deployable aerodynamic tail that includes an inflatable portion. FIG. 44 illustrates a rear perspective view of a transport unit that includes a deployable aerodynamic tail having an inflatable portion with a triangle shaped cross section. FIG. 45 illustrates a rear perspective view of a transport unit that includes a deployable aerodynamic tail having a dome shaped inflatable portion. FIGS. 46 and 47 illustrate rear perspective views of a transport unit that includes an aerodynamic tail having an inflatable portion and a non-inflatable portion, according to two different embodiments.

FIGS. 48A and 48B illustrate a rear perspective view of a transport unit that includes another embodiment of an aerodynamic tail. FIG. 48A illustrates the aerodynamic tail in a folded state. FIG. 48B illustrates the aerodynamic tail in a deployed state.

FIGS. 49A and 49B illustrate a storage structure attached to a rear door of a transport unit that can be used to store folded aerodynamic tails as disclosed herein. FIG. 49A illustrates a rear view of a transport unit equipped with the storage structure. FIG. 49B illustrates a cross section view of line 49B-49B in FIG. 49A.

FIG. 50A illustrates a rear perspective view of a transport unit with a trailer tail in a closed position, according to one embodiment.

FIG. 50B illustrates a rear perspective view of a transport unit with a trailer tail in an open position, according to one embodiment.

FIG. 51 illustrates a method and system for detecting, communicating and controlling the status of a trailer tail, according to one embodiment.

FIG. 52A illustrates a back perspective view of a transport unit with a lift gate in a closed position, according to one embodiment.

FIG. 52B illustrates a back perspective view of a transport unit with a lift gate in an open position, according to one embodiment.

FIG. 53 illustrates a flowchart of a method for detecting, communicating and controlling the status of a lift gate, according to one embodiment.

### DETAILED DESCRIPTION

A transport unit (e.g. a temperature controlled transport unit), such as a tractor trailer or truck trailer, a container on a flat car, an intermodal container, etc., may be transported by, for example, a tractor, a train, a ship, etc. When the transport unit is in motion, the tractor and the transport unit may create aerodynamic drag, which may reduce, for example, fuel economy of the tractor.

### Part I: Airflow Director

In some transport units that may move at a relatively high speed (e.g. 60 mph or above), such as a truck trailer, movements of the transport units may result in various conditions external to the transport units. For example, when moving at relatively higher speeds, there can be the occurrence of relatively higher pressure areas and relatively lower pressure areas in relation to certain areas external to the transport units. Turbulent flows may occur at relative external areas of the transport unit, and/or increased aerodynamic resistance (e.g. aerodynamic drag) may occur. Any or all of such conditions can result in decreased fuel efficiency. It is desirable to design a transport unit with such conditions in mind to provide a transport unit that provides advantageous fuel efficiency when in motion.

The embodiments described herein are related to airflow director structures, apparatuses, mechanisms, and methods for a transport unit where, in some cases for example, the transport unit is temperature controlled by a transport refrigeration unit (TRU). More specifically, the disclosure herein is directed to systems, apparatuses, mechanisms, and methods related to directing airflow to low pressure areas in relation to the transport unit, such as for example external to the transport unit, such as toward the rear of the transport unit, which can improve energy efficiency, counter turbulent airflows, and/or reduce drag.

References are made to the accompanying drawings that form Part I hereof, and in which is shown by way of illustration of the embodiments in which the embodiments of Part I may be practiced. It is to be understood that the terms used herein are for the purpose of describing the figures and embodiments of Part I and should not be regarded as limiting the scope. In some embodiments, the airflow director implementations herein can be configured to direct an airflow to a relatively low pressure region, such as for example at a rear end of the transport unit when the transport unit is in motion. In some embodiments, the airflow director implementations can be configured to reduce or eliminate the relatively low pressure region. Depending on the design, the airflow director implementations are disposed on various locations of the transport unit, may use certain resources and structures available from the transport unit.

References are made to the accompanying drawings that form a part hereof, and in which is shown by way of illustration of the embodiments in which the embodiments may be practiced. It is to be understood that the terms used herein are for the purpose of describing the figures and embodiments and should not be regarded as limiting in scope.

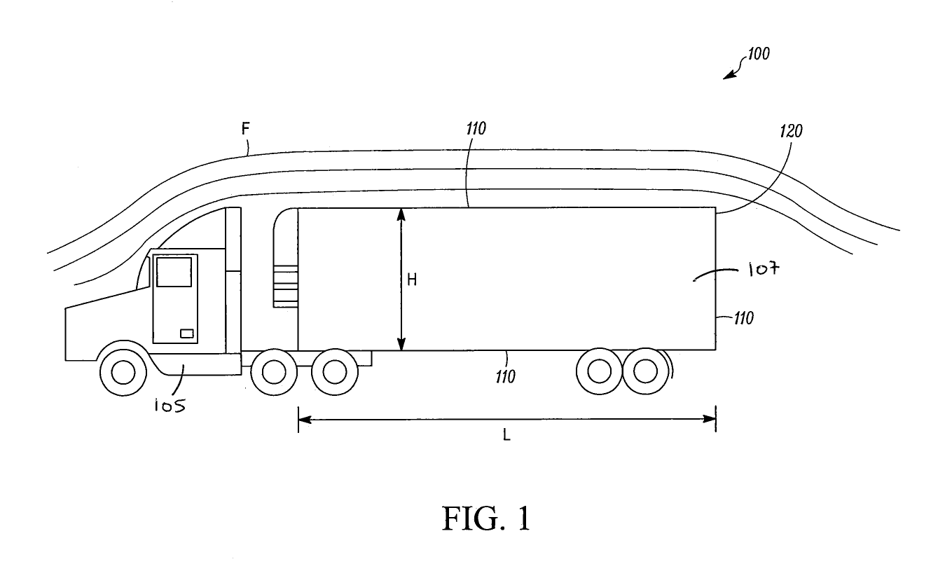

FIG. 1 illustrates a tractor trailer 100 with which the embodiments as disclosed herein can be practiced. It will be appreciated that the airflow director implementations disclosed herein may be suitable for use in other types of transport units, such as for example any unit, which may be used for transport, e.g. a truck, a trailer, a container, a train, an airplane, or a ship. Referring to FIG. 1, the tractor trailer 100 includes a tractor 105 attached to a transport unit 107. When the tractor trailer 100 is in motion air flows (e.g. F) are shown around the transport trailer 100, and relatively low pressure region and/or turbulent flows 110 may form near a rear end 120 of the transport unit 100. It will be appreciated that such conditions as relatively low pressure region and/or turbulent flows 110 may also exist at other areas of the tractor trailer 100, such as at the top, sides, bottom, and the like. Such conditions as low pressure regions and/or turbulent flows 110 around the tractor trailer 100 can cause reduced fuel efficiency. Systems, apparatuses, devices, mechanisms, and methods are described herein, which are directed to reduce or eliminate such relatively low pressure regions and/or turbulent flows 110, and can advantageously reduce aerodynamic drag, and result in increased fuel efficiency.

It will be appreciated that the airflow director implementations herein may be disposed at various locations on the tractor trailer 100 and may employ various resources and structures available from the tractor trailer 100. For example, such locations may be anywhere on the sides along the height H or length L of the transport unit 107, anywhere on the bottom and/or top of the tractor trailer 100 along the length L, or at the front of the transport unit 107 (e.g., the area where the tractor 105 connects to the transport unit 107) or at the rear of the transport unit 107.

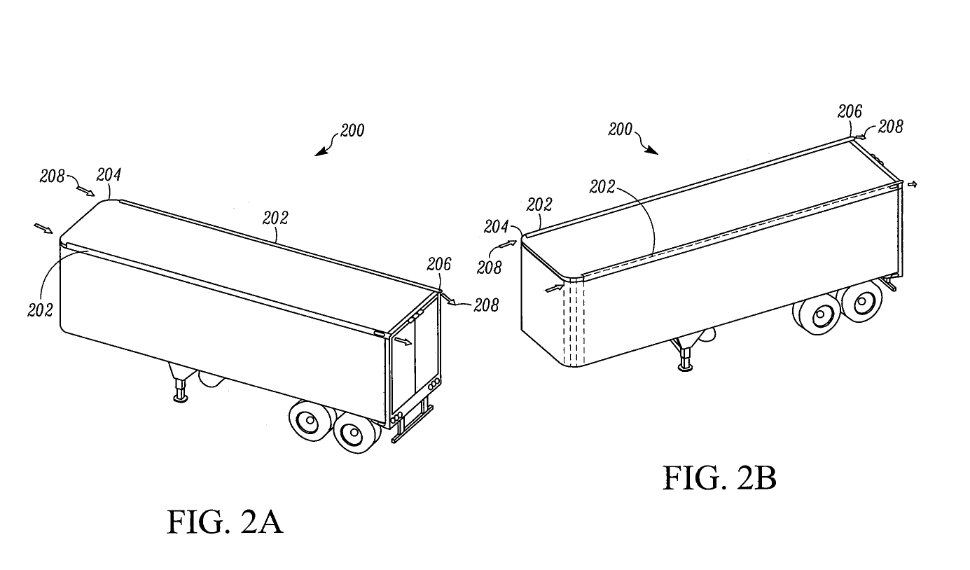

FIGS. 2A through 4B illustrate embodiments of directing airflow by way of implementing one or more channels on the transport unit (e.g., the transport unit 107 shown in FIG. 1).

FIGS. 2A and 2B illustrate one embodiment of directing airflow by way of a channel 202 extending along the transport unit 200.

As shown, the channels 202 define an inlet 204, such as for example toward the front of the transport unit 200 and an outlet 206 toward the rear of the transport unit 200. As shown by arrows 208, airflow enters the inlet 204, flows through the channel 202, and exits the outlet 206. The channels 202 in the embodiment shown are externally disposed on the outer of the transport unit 200, extend substantially along the length of the transport unit 200 from the front to the rear, and are located at top corners of the transport unit 200. Two channels 202 are shown. It will be appreciated that the number, location, and extension of the channels 202 is merely exemplary. For example, the channels 202 may be disposed at other locations than the top corners, such as for example anywhere on the sides, on the bottom, or on the top, and which may or may not be at the corners. Likewise, the channels 202 may not extend the length of the transport unit 200, but may extend less than the length of the transport unit 200, and there may be one or more than two channels 202.

In some embodiments, the channels 202 as shown can be configured as hollow type structures on the transport unit, which are external structures added onto the outside of the transport unit, such as an add on accessory.

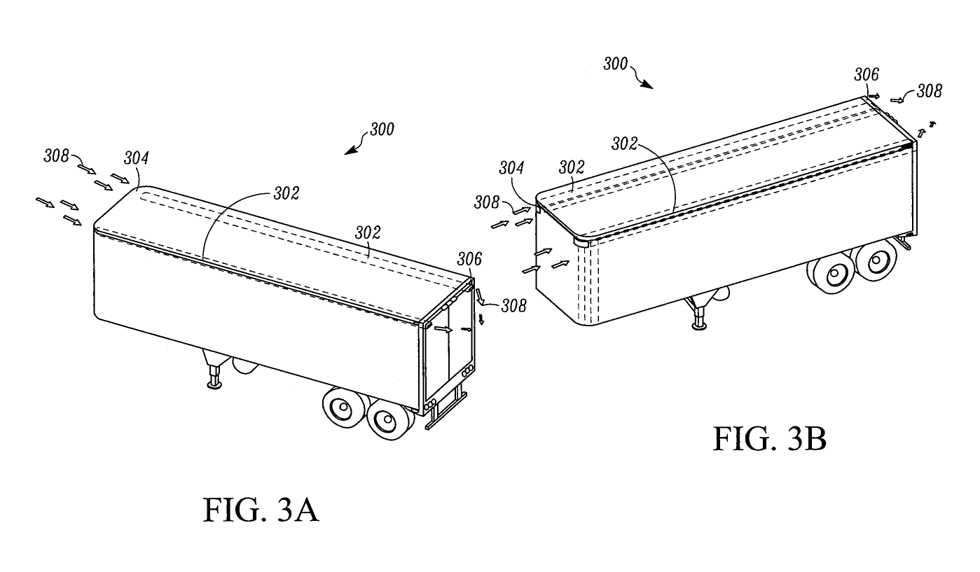

FIGS. 3A and 3B illustrate one embodiment of directing airflow by way of a channel 302 extending along the transport unit 300.

As shown, the channels 302 define an inlet 304, such as for example toward the front of the transport unit 300 and an outlet 306 toward the rear of the transport unit 300. As shown by arrows 308, airflow enters the inlet 304, flows through the channel 302, and exits the outlet 306. The channels 302 in the embodiment shown, extend substantially along the length of the tractor from the front to the rear, and are located at top corners of the transport unit 300. Two channels 302 are shown. It will be appreciated that the number, location, and extension of the channels 302 is merely exemplary. For example, the channels 302 may be disposed at other locations than the top corners, such as for example anywhere on the sides, on the bottom, or on the top, and which may or may not be at the corners. Likewise, the channels 302 may not extend the length of the transport unit 300, but may extend less than the length of the transport unit 300, and there may be one or more than two channels 302.

In some embodiments, the channels 302 as shown can be configured as hollow type structures on the transport unit, which are internal structures such as may be constructed, arranged, or otherwise built within a wall structure of the transport unit 300. In some embodiments, the wall structure of the transport unit 300 may include a false ceiling or sides, which may extend the length or at least a portion of the length of the transport unit 300 to accommodate the channels 302.

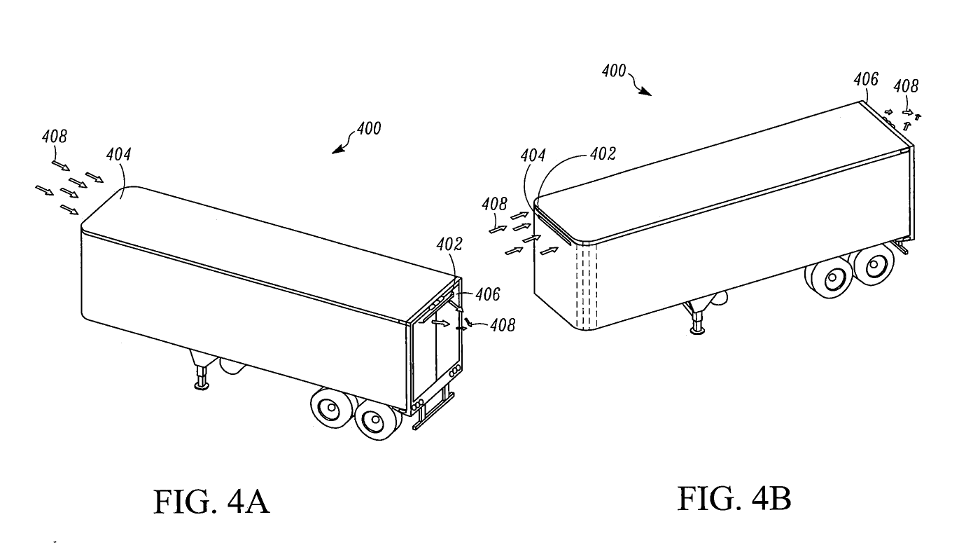

FIGS. 4A and 4B illustrate one embodiment of directing airflow by way of a channel 402 extending along the transport unit.

As shown, the channel 402 defines an inlet 404, such as for example toward the front of the transport unit 400 and an outlet 406 toward the rear of the transport unit 400. As shown by arrows 408, airflow enters the inlet 404, flows through the channel 402, and exits the outlet 406. The channel 402 in the embodiment shown, extend substantially along the length of the transport unit 400 from the front to the rear of the transport unit 400. One channel 402 is shown, and is disposed along the top of the transport unit 400. It will be appreciated that the number, location, and extension of the channel 402 is merely exemplary. For example, the channel 402 may be disposed at other locations than the top, such as for example anywhere on the sides, on the bottom, and which may or may not be on top of the transport unit 400. Likewise, the channel 402 may not extend the length of the transport unit 400, but may extend less than the length of the transport unit 400, and there may be one or more than two channel 402.

In some embodiments, the channel 402 as shown can be configured as a hollow type structure on the transport unit 400, which are internal structures such as may be constructed, arranged, or otherwise built within a wall structure of the transport unit 400. In some embodiments, the wall structure of the transport unit 400 may include a false ceiling or sides, which may extend the length or at least a portion of the length of the transport unit 400 to accommodate the channel 402.

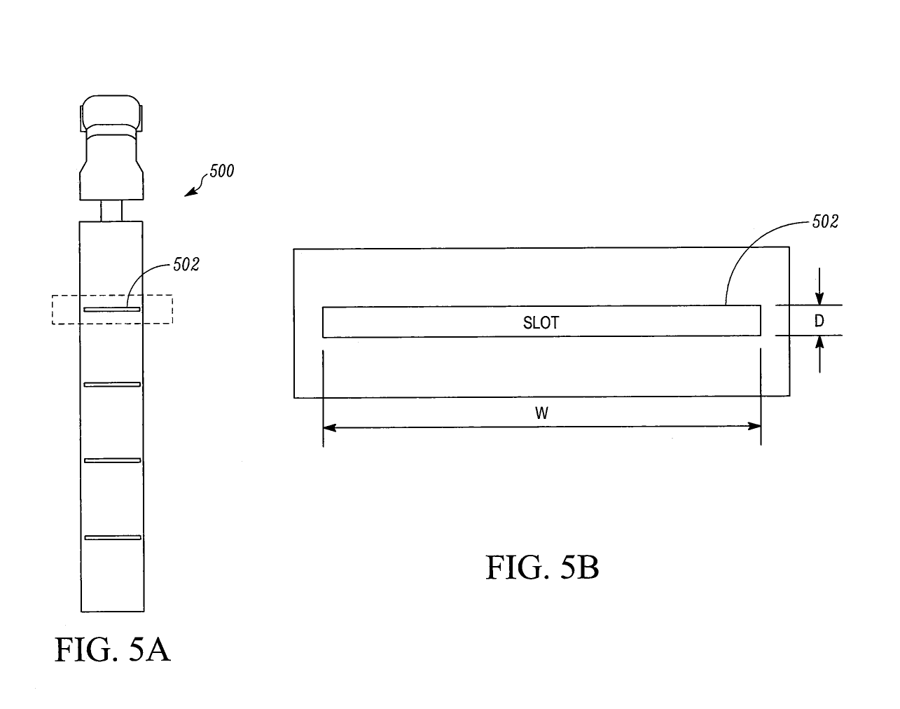

FIG. 5A and 5B illustrate one embodiment of directing airflow by way of channels extending along a transport unit 500, such as for example implemented as cross slots in the wall structure of the transport unit 500.

As shown, channels 502 provide slots that extend along the width direction of the transport unit 500. In some embodiments, the channels 502 are constructed within the wall structure of the transport unit 500. In other embodiments, the channels 502 may be a structure added externally onto the transport unit 500, such as for example as a skin with channels 502 therein.

Such as shown in FIG. 1, airflow F flows over the top of the transport unit (e.g. 110) 500 when the transport unit is in motion, the airflow enters into and flow out of the channels 502, which can streamline flow toward the rear of the transport unit. As shown, in some embodiments, there can be multiple channels 502 along the width of the transport unit 500 and spaced along the length of the top of the transport unit 500. The channels 502 can have a depth D (e.g. into the top of the transport unit 500) that can vary, which in some embodiments, is at or about six inches. The width W of the channels can vary, and can be at or about 90 inches. It will be appreciated that the number, location, and extension of the channels 502 is merely exemplary. For example, the channels 502 may be disposed at other locations than the top, such as for example anywhere on the sides, on the bottom, and which may or may not be on top of the transport unit 500. Likewise, the channels 502 may not extend the width of the transport unit 500, but may extend less than the width of the transport unit 500, and there may be channels 502 that have different depths D and widths W on the same transport unit 500. In some embodiments, the channels 502 may not be slots as shown in FIGS. 5A and 5B, but can have other configurations, geometries, dimensions, and the like.

In some embodiments, the channels 502 as shown may be constructed, arranged, or otherwise built within a wall structure of the transport unit 500 or as an add on type of accessory. In some embodiments, it has been observed under certain fluid dynamics testing, that inclusion of channels, such as channels 502 aerodynamic drag was reduced by about 4%, which could lead to a fuel savings of about 3.5% when a transport unit is moving at about 75 miles/hour. The flow entering the channels 502 can experience similar negative pressures which may be experienced by other areas around the transport unit 500 such as at the rear, where the channels 502 can help streamline air flow towards the rear of the transport unit 500, increasing the pressure which can assist in reducing drag that may be experienced overall by the transport unit 500. The channels 502 may contribute some drag, however, the contribution to the rise in pressure at the rear reduces overall drag.

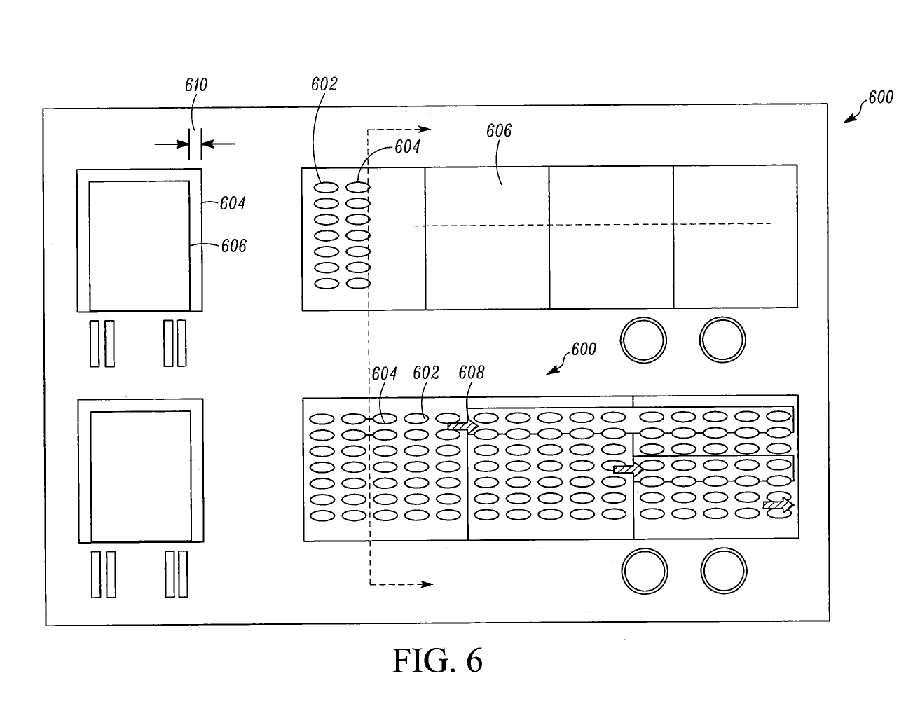

FIG. 6 illustrate embodiments of directing airflow by way of channels 602 extending along the transport unit 600, such as for example implemented as openings in the wall structure of the transport unit 600.

Rather than the use of slots for channels, the channels 602 of the transport unit 600 are openings, e.g. perforations or holes on sides and/or the top of the transport unit 600. As shown, the channels 602 have the openings 604, which allow airflow to be directed into the openings 604 toward the wall structure 606 of the transport unit 600. As shown by arrows 608, air flows into and through the channels 602 by entering and exiting the openings 604, flows along the sides of the wall structure 606, and flows toward the rear of the transport unit 600. At 610, there is shown a width (see arrows), which show a space between the wall structure 606 and the openings 604. The space allows the airflow to experience the negative pressure similar to the channels 602 (e.g. slots), and can provide about the same or in some cases better effects relative to the channels 602. As shown, there are multiple openings 604, and the number of openings, their size, their geometry, and the like are not meant to be limiting and can vary as desired and/or necessary.

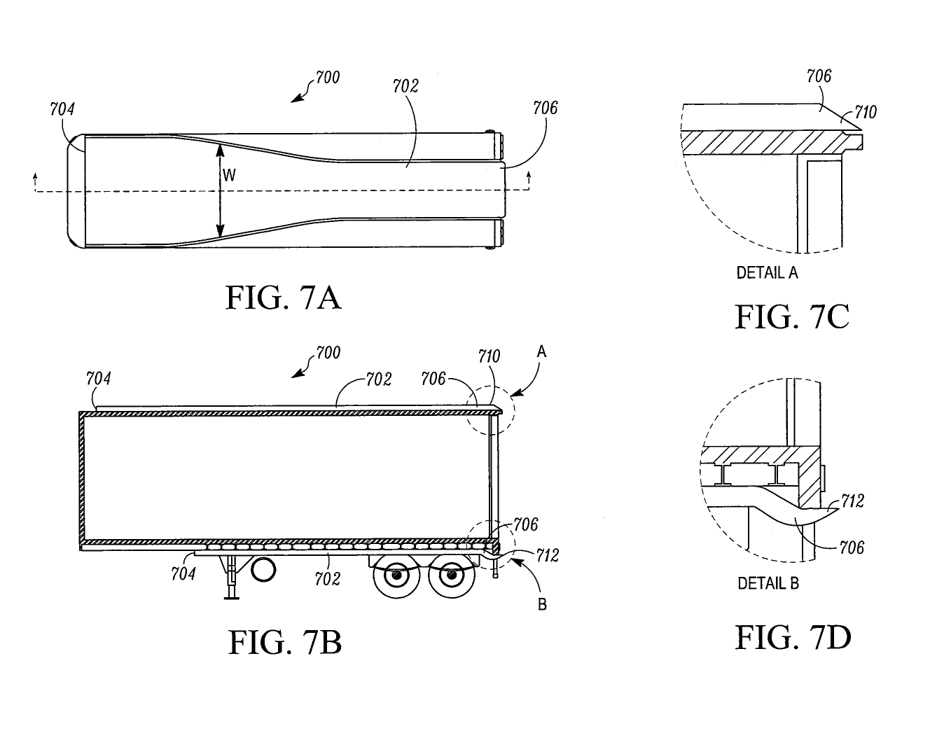

FIGS. 7A through 7D illustrate embodiments of directing airflow by way of using end structures, such as a scoop, which in some embodiments may be implemented with channels extending along a transport unit 700.

In some embodiments, end or terminal structures may be implemented to further facilitate airflow direction. In some embodiments, such end or terminal structures are scoop type features, which may be disposed at ends of channels. As shown in FIGS. 7A through 7D, a top channel 702, which may be configured as a duct similar to FIGS. 4A and 4B can include a terminal structure 710, such as may be constructed as a scoop. A bottom channel 702 can also include scoop 712. As shown, the scoops 710, 712, have somewhat different configurations, e.g. curved and/or angled walls, which are designed to direct or divert flow in certain directions, e.g. downward (e.g. as in 710) or upward (e.g. as in 712). As shown, the scoops 710, 712 are located on the channels toward the outlet 706 or rear of the transport unit 700. It will be appreciated that end or terminal structures such as 710, 712 may also be implemented on the channels toward the inlet 704 or front of the transport unit 700. With further reference to the top channel 702, it will be appreciated that a width W can vary along the channel 702, such as from the inlet 704 to the outlet 706.

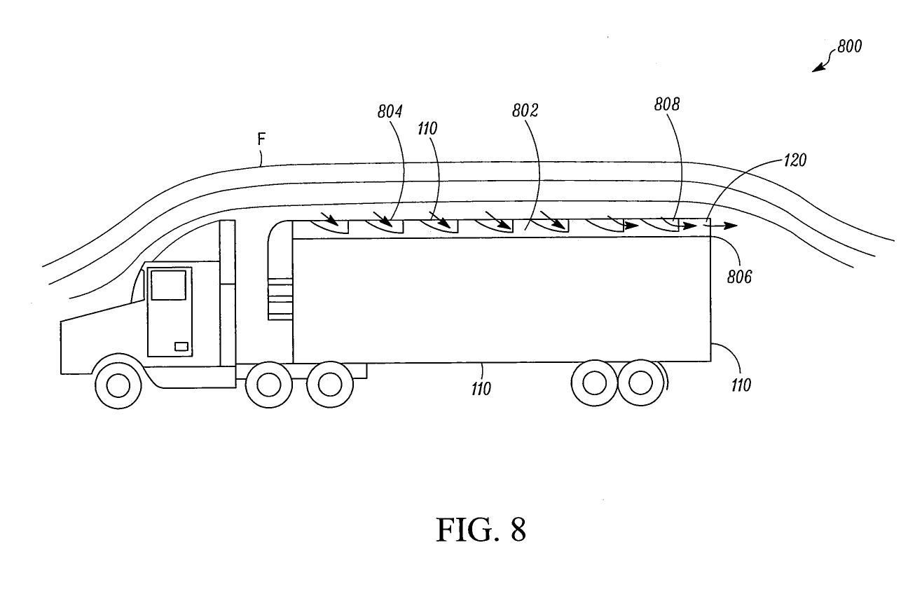

FIG. 8 illustrates one embodiment of directing airflow by way of a channel 802 extending along a transport unit 107 (e.g., the transport unit 107 shown in FIG. 1) of a tractor trailer 800, and which in some embodiments, includes one or more baffles 804 in the channel 802.

The transport unit 107 is shown with a channel 802, which may extend the length of the transport unit 810. In the embodiment shown, the channel 802 can have one or more baffles 804 at various locations of the channel 802 to direct airflow into the channel 802 and to the outlet 806 (see arrows 808). In some embodiments, the baffles 804 are one-way passages that direct airflow toward low pressure areas. In some embodiments, the channel(s) 802, baffles 804, outlet 806 may be formed as a separate skin or add on accessory onto the transport unit 107 or be built in the wall structure of the transport unit 107.

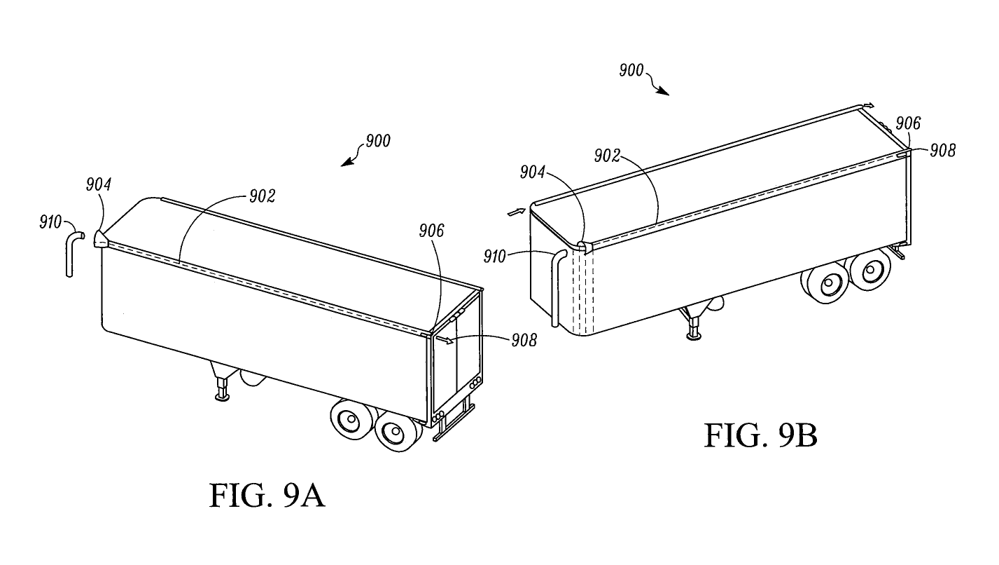

FIGS. 9A and 9B illustrate one embodiment of directing airflow by way of sourcing air, such as heated air from exhaust 910, which in some embodiments may be implemented with channels 902 extending along a transport unit 900.

It will be appreciated that the source of air whether heated or not, may come from various resources including already available resources of the transport unit or as a dedicated source. As shown in FIGS. 9A and 9B, a sourcing passage 910, such as for example an exhaust pipe which may be fluidly connected to the truck exhaust and/or a TRU exhaust, can be employed to source the airflow that is to be directed to the negative pressure area(s). In the embodiments, shown, the sourcing passage 910 is fluidly connected to an inlet 904 of a channel 902, to direct airflow to the outlet 906 (see arrow 908). It will be appreciated that the source of air flowing into the sourcing passage 910 can be from various air sources, such as for example but not limited to the truck exhaust, TRU exhaust, a dedicated air source, e.g. a fan, or the like. It will also be appreciated that the sourcing passage 910 does not have to be implemented with a channel as specifically shown in FIGS. 9A and 9B, but could be through some other suitable delivery passage at various locations of the transport unit 900.

In the example of using exhaust air as the source delivered to the sourcing passage 910, the transport unit 900 can utilize an air expansion, e.g. of heating, using already available resources to increase air and volume and then discharge to negative pressure areas.

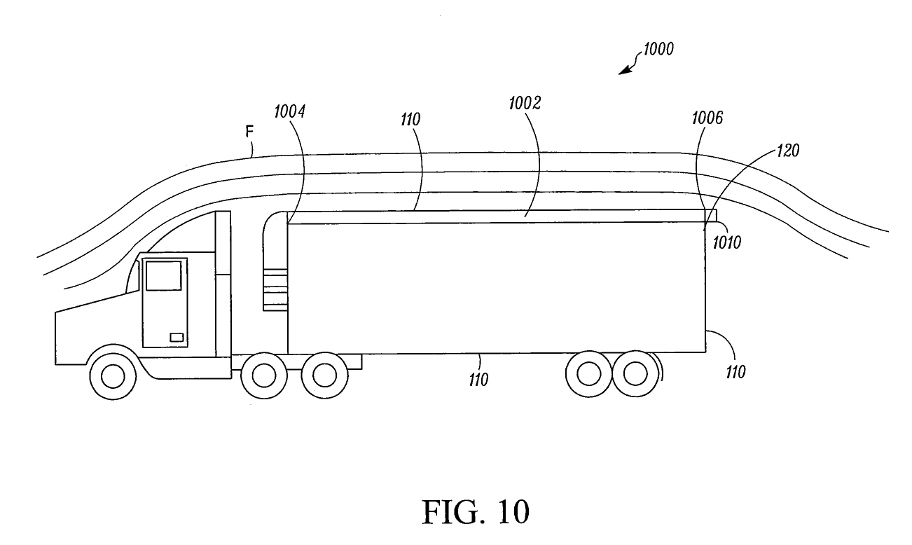

FIG. 10 illustrates one embodiment of directing airflow by way of an ejector in a tractor trailer 1000, which in some embodiments may be implemented with a channel extending along a transport unit 107, and may source air from various locations, such as a discharge from a TRU.

The transport unit 107 (e.g., the transport unit 107 shown in FIG. 1) is shown with a channel 1002. In some embodiments, it may be useful to employ end or terminal structures, which modify the velocity of the airflow. For example, a terminal structure 1010 may be employed, which can be an ejector, a venturi or capillary. In the embodiment shown, the terminal structure 1010 is disposed toward a rear end of the tractor trailer 1000 and is implemented at an outlet 1006 of a channel 1002. Air flows into the inlet 1004 through the channel 1002, and exits the outlet 1006 through the terminal structure 1010, which can further direct, divert, amplify and/or modify the velocity of the airflow exiting the channel 1002. It will be appreciated that the terminal structure 1010 is not limited to implementation with the specific channel or flow passageway shown in FIG. 10.

In some embodiments, the source of air can be for example, compressed air, or can be exhaust from the TRU (e.g. as in FIG. 9A and 9B). For example, air flow can be sourced as compressed air or exhaust, such as from the TRU or another source, and can be directed through a passageway, such as for example channel 1002 (can be other types of channels), and may further be directed through a terminal structure such as an ejector, scoop, diverter, and the like.

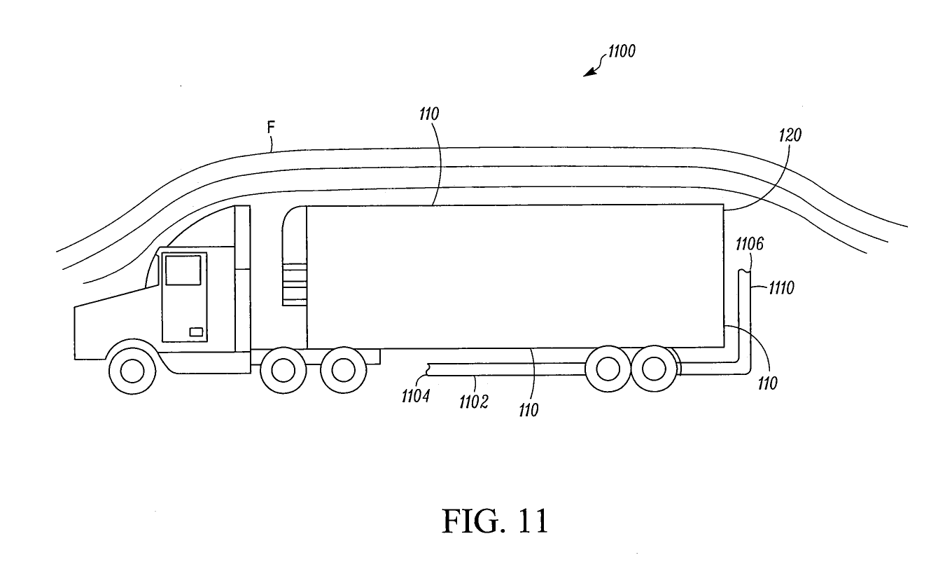

FIG. 11 illustrates one embodiment of directing airflow by way of a duct, which in some embodiments may extend along the transport unit and may source air from various discharge locations of the transport unit.

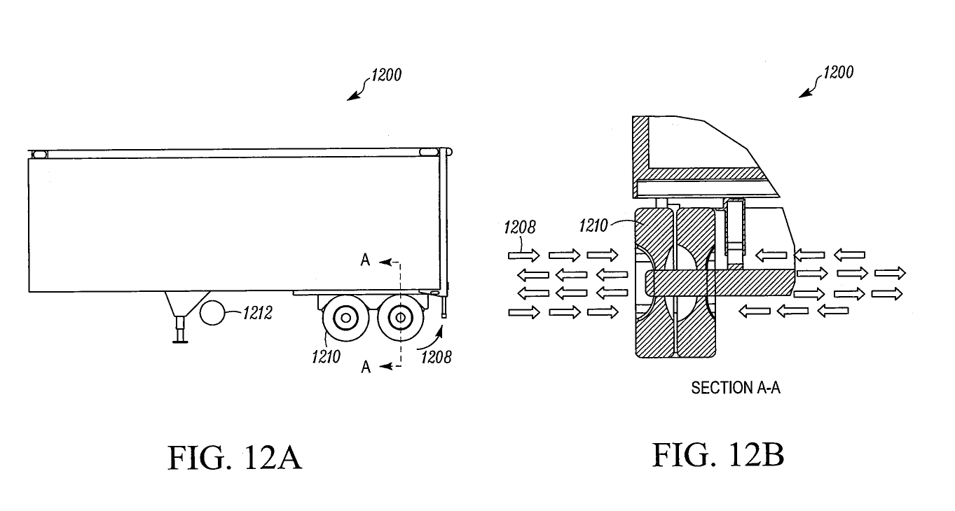

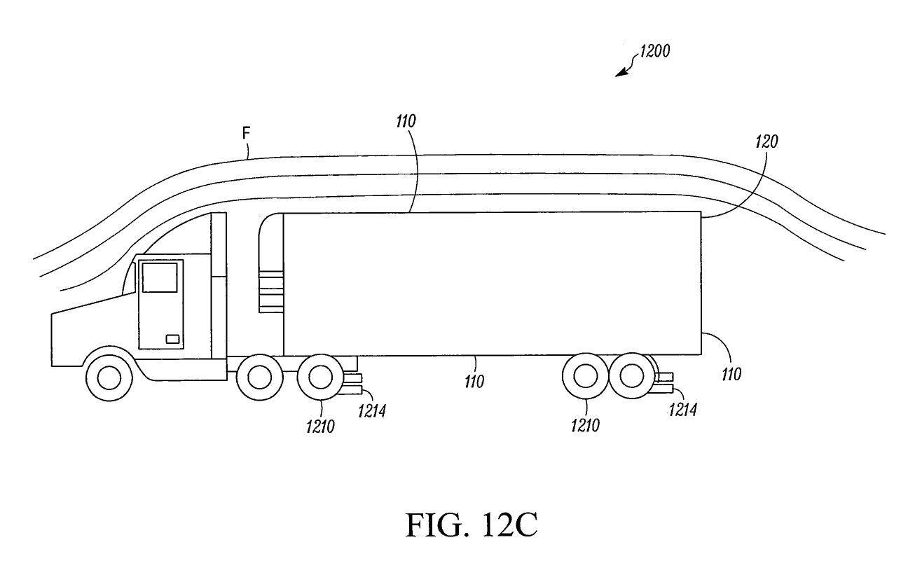

It will be appreciated that various sources can be used to provide the airflow, and that various discharge configurations may be employed to direct, divert, or otherwise deliver the airflow to a desired location, e.g. low pressure areas. FIG. 11 shows a tractor trailer 1100 with a transport unit 107 (e.g., the transport unit 107 shown in FIG. 1). Generally, an inlet 1104 of an airflow director 1102, which may be a duct, channel or other passageway can be used to direct an airflow to an outlet 1106. In the embodiment shown, the airflow director is a duct 1110 extending along the bottom of the transport unit 107, toward, and upward along the rear of the transport unit 107. The inlet 1104 is intended to show that the source of airflow can be from various different sources and/or locations, and the outlet 1106 can be configured with various different types and/or locations of discharge. For example, in some embodiments, air can be ducted using various locations for and sizes of the duct, such as along the transport unit floor to deliver air from the front to the low pressure area(s), e.g. the rear. In some embodiments, it will be appreciated that the duct 1110 may be a retractable type of structure such as when not in use. FIGS. 12A through 12C illustrate embodiments of directing airflow by way of sourcing and diverting air from an area proximate the tractor trailer wheels.

It will be appreciated that other sources of air may be used to direct air from a relatively high pressure area to a relatively low pressure area. In the embodiment shown, tractor trailer wheels 1210 of a tractor trailer 1200 may be used as the mechanism providing the source of air, e.g. when rotating, to be directed to a low pressure area. In some embodiments, the wheels 1210 when in operation can drive airflow toward the back of the tractor trailer 1200. In some embodiments, the air generated by the rotating wheels can be directed behind the wheels into low pressure areas, e.g. vacuum bubbles. In some embodiments, tangential airflow from a tire perimeter (see arrows 1208 from FIGS. 12B) may be captured by using another mechanism, such as another wheel, e.g. a central wheel 1212. In some embodiments, the wheel 1212 may also be used as a fan to direct airflow. In some embodiments, such as shown in FIG. 12C, the tractor trailer 1200 can implement additional ducts 1214, e.g. relatively short passages may be disposed behind the wheels 1210 to further direct the airflow captured by the wheels 1210 and/or tires.

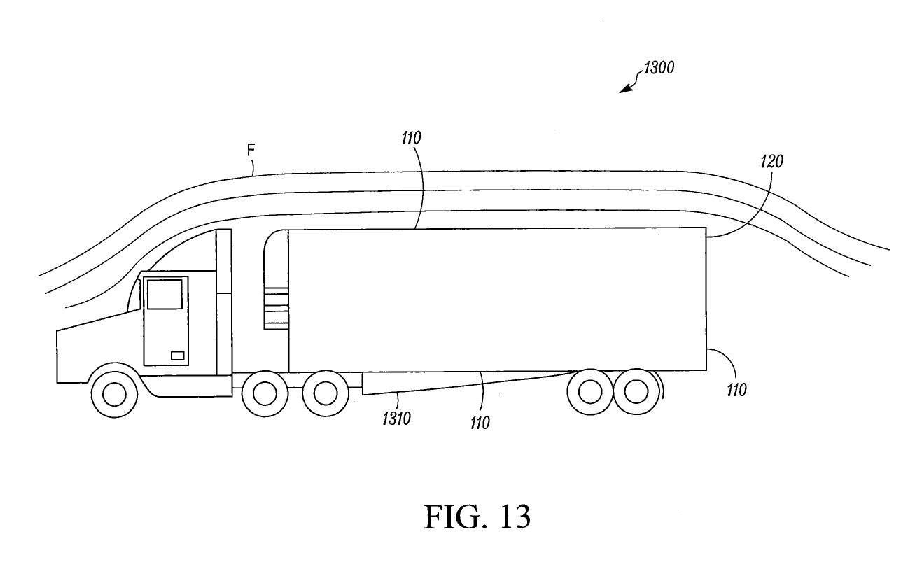

FIG. 13 illustrates one embodiment of directing airflow by way of a bottom structure underneath the transport unit that in certain circumstances smoothens airflow.

FIG. 13 shows a tractor trailer 1300 with a transport unit 107 (e.g., the transport unit 107 shown in FIG. 1). In some embodiments, structures may be employed to smoothen airflow, e.g. various structures with surfaces and/or contours that can smoothen airflow. In FIG. 13, the tractor trailer 1300 in some embodiments can employ structures 1310, e.g. ramp like structures, to help direct and smoothen airflow toward low pressure areas, e.g. the rear of the tractor trailer 1300. It will be appreciated that the specific structure shown in FIG. 13 is not meant as limiting, as the ramp can have different configurations, and may or may not employ a ramp at all.

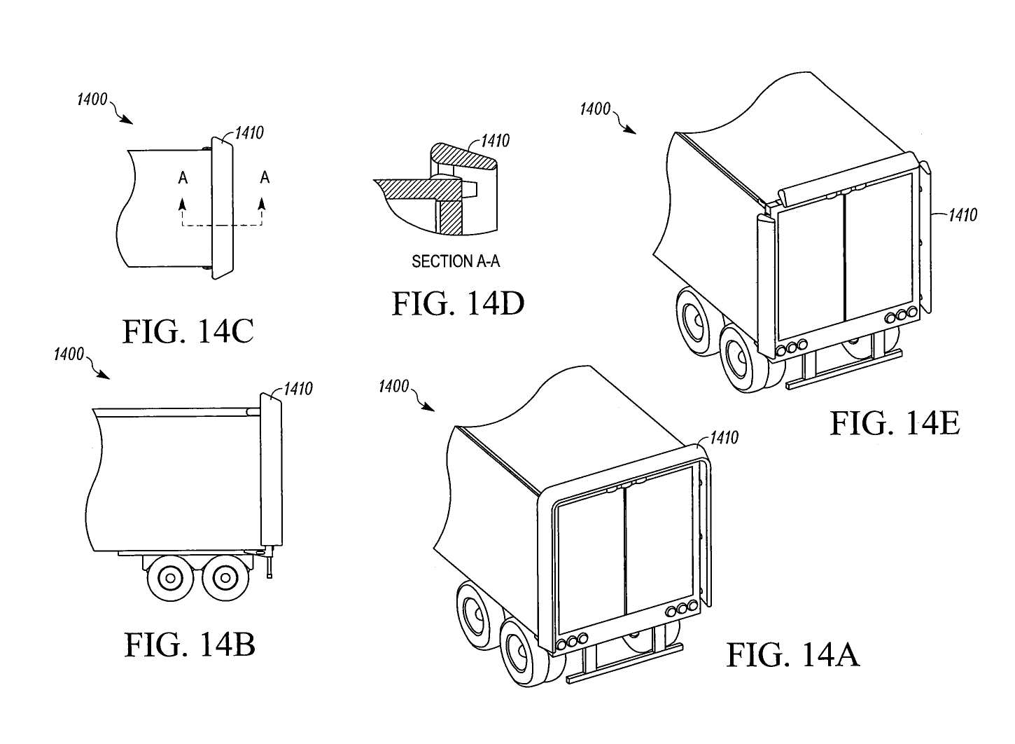

FIGS. 14A through 20D show various relatively angled structures with respect to walls of the transport unit, and may be structured for example as louver and/or vane type structures. Such structures can provide manual or retractable type structures, which may also include or be like wings and may be stored in or on sides and/or the top of the transport unit. Other suitable wings, foils, whether pop out/retractable may be employed.

FIGS. 14A through 14E illustrate embodiments of directing airflow by way of implementing relatively angled structures with respect to walls of the transport unit, such as for example louvers.

The transport unit 1400 has vanes 1410 which in the embodiment shown are fixed to walls of the transport unit 1400, and are disposed on sides and the top of the transport unit 1400. It will be appreciated that the vanes 1410 can be add on accessories to the transport unit 1400. In some embodiments, one unitary structure surrounding the top and sides (e.g. shown in FIGS. 14A through 14D) can be used, or separate pieces can make up the vanes and surround the top corners of the transport unit 1400. In some embodiments, the vanes 1410 can be separate pieces that do not cover the corners (e.g. shown in FIG. 14E).

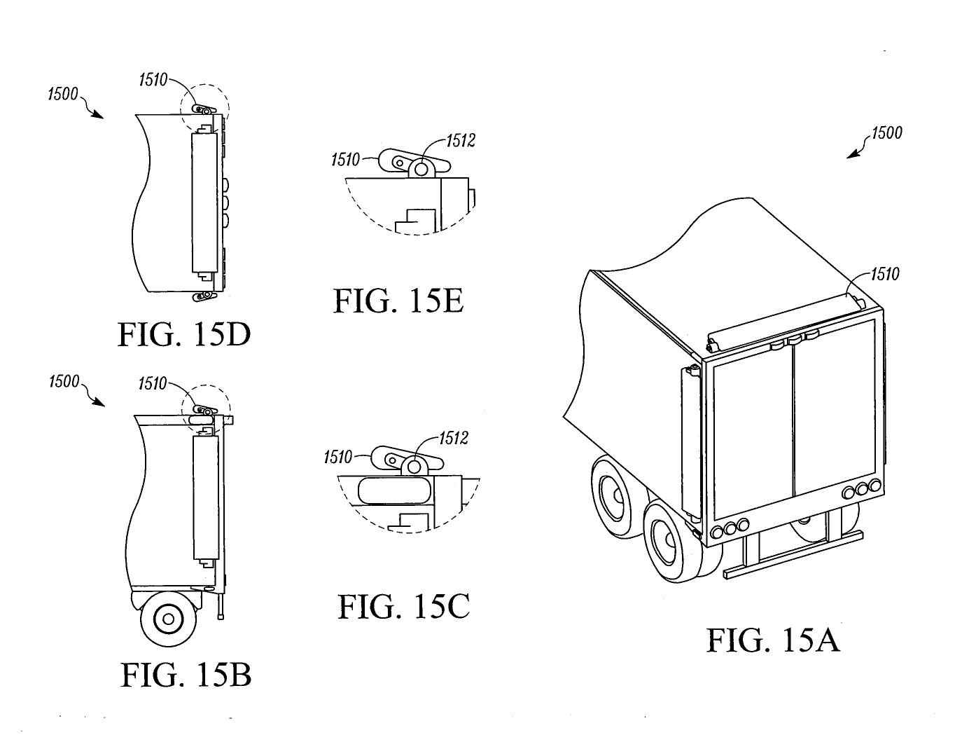

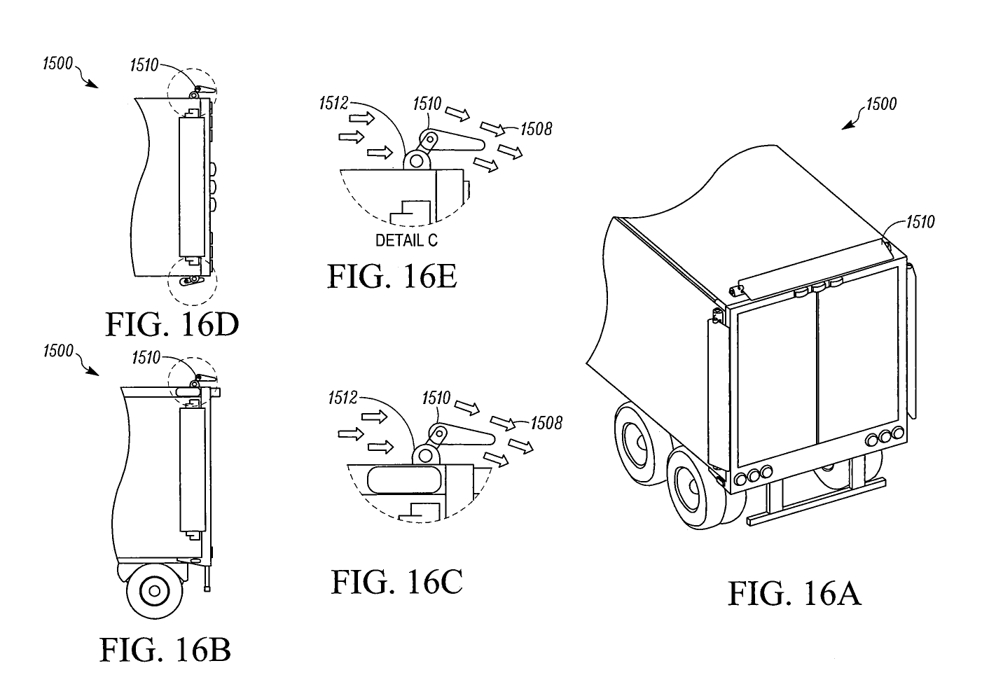

FIGS. 15A through 16E illustrate one embodiment of directing airflow by way of implementing relatively angled structures with respect to walls of the transport unit, such as for example vanes or louvers.

The transport unit 1500 can include vanes 1510 similar to those in FIG. 14, but where the vanes 1510 may be put into deployed and non-deployed positions. FIGS. 15A through 15E show the vanes 1510 in a non-deployed position. FIGS. 16A through 16E show the vanes 1510 in the deployed position where air flow (see arrows 1508) around, along the vane 1510 structure. In some embodiments, a mechanism 1512 is used to move the vanes 1510 into/out of the deployed, non-deployed positions.

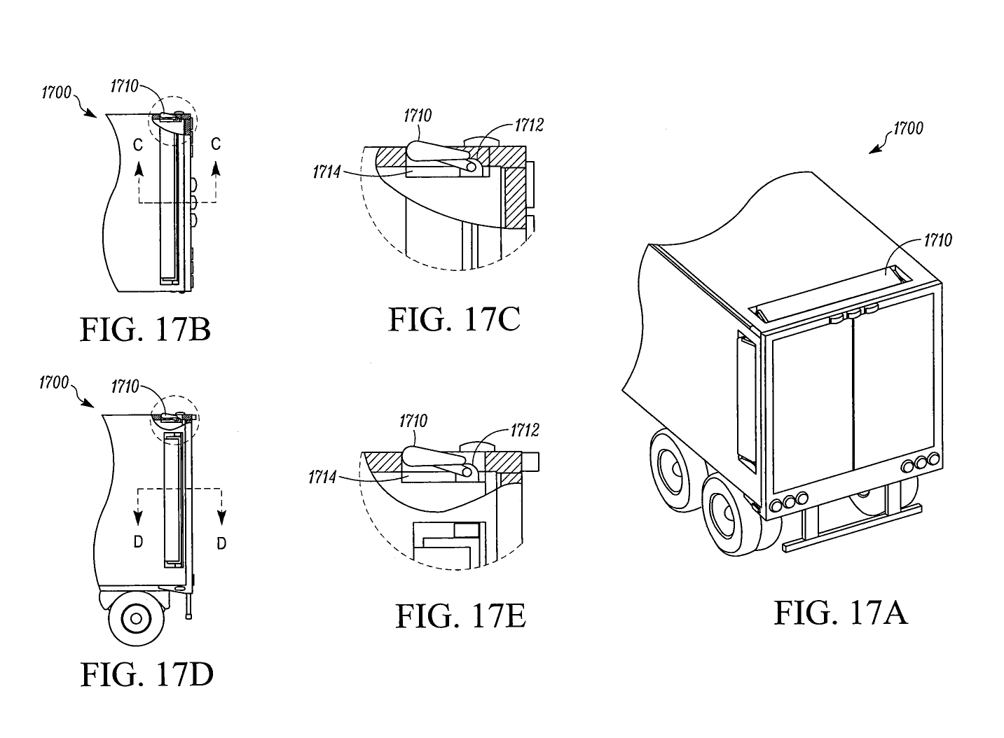

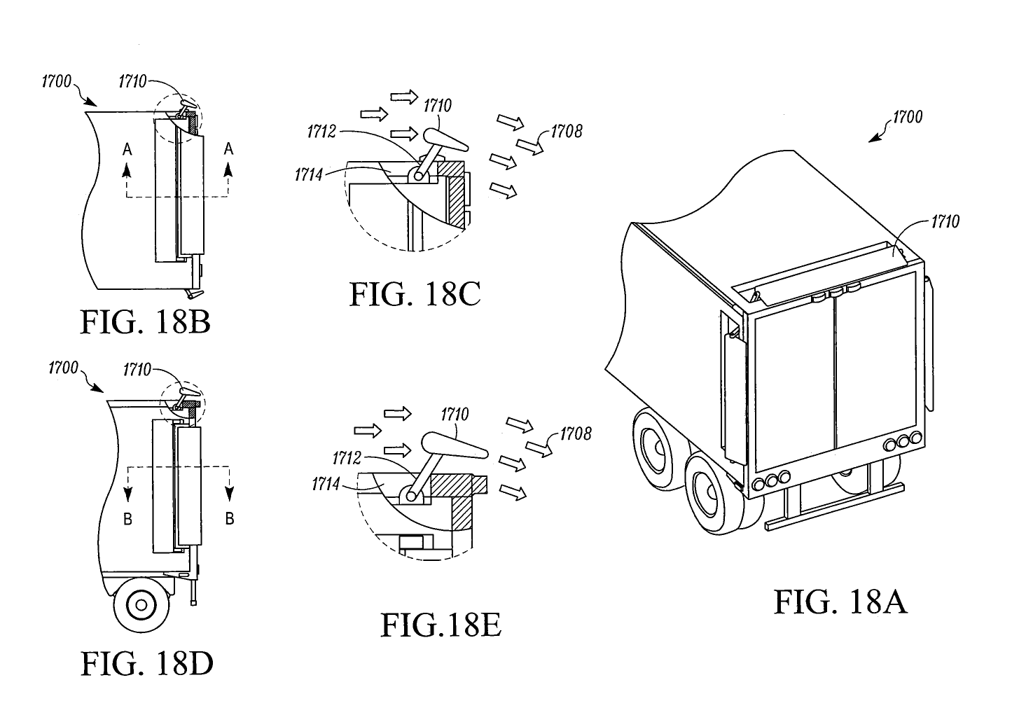

FIGS. 17A through 18E illustrate one embodiment of directing airflow by way of implementing relatively angled structures with respect to walls of the transport unit, such as for example vanes or louvers.

The transport unit 1700 can include vanes 1710 similar to those in FIG. 14, but where the vanes 1710 may be put into deployed and non-deployed positions and where the transport unit includes a recessed area 1714 to allow the vanes to be recessed and not protrude from the general outer wall structure of the transport unit 1700. FIGS. 17A through 17E show the vanes 1710 in a non-deployed position. FIGS. 18A through 18E show the vanes 1710 in the deployed position where air flow (see arrows 1708) around, along the vane 1710 structure. In some embodiments, a mechanism 1712 is used to move the vanes 1710 into/out of the deployed, non-deployed positions.

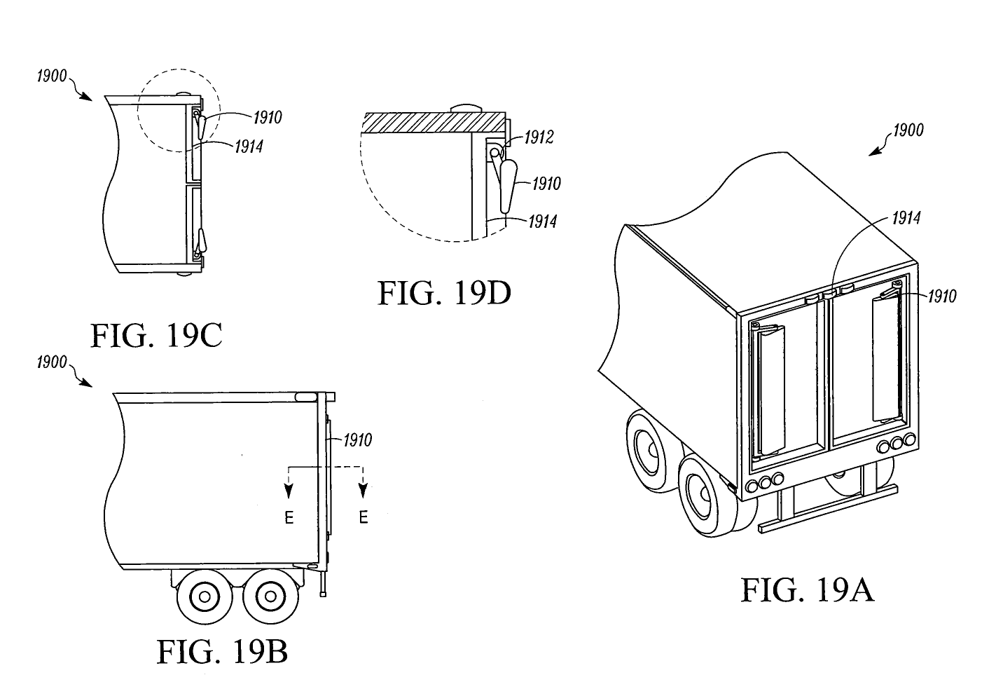

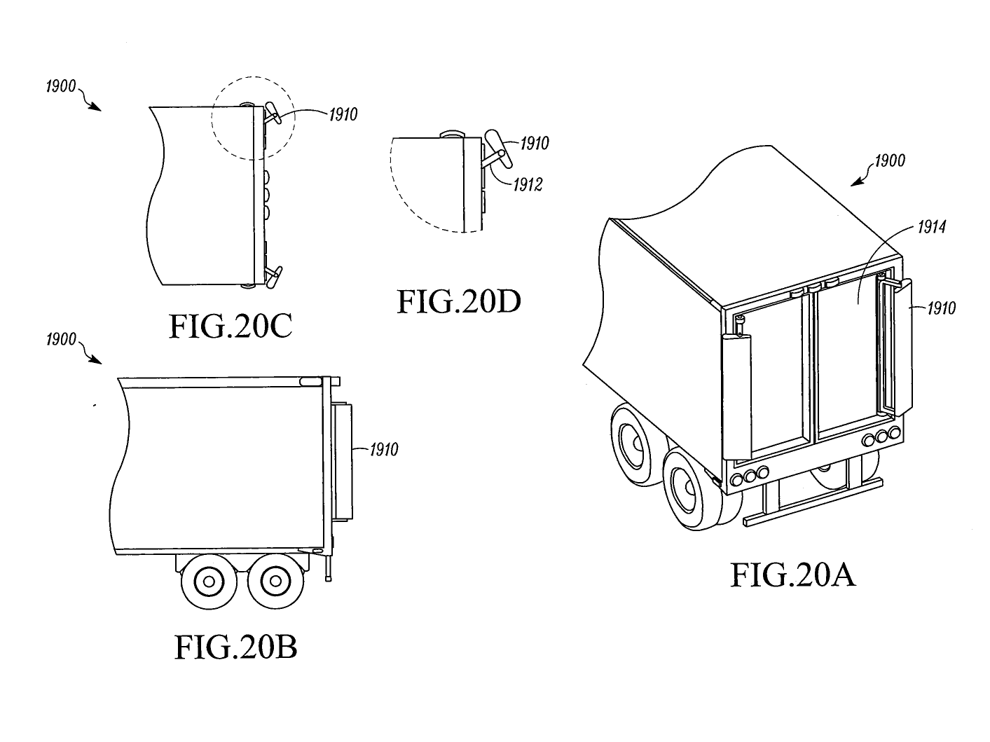

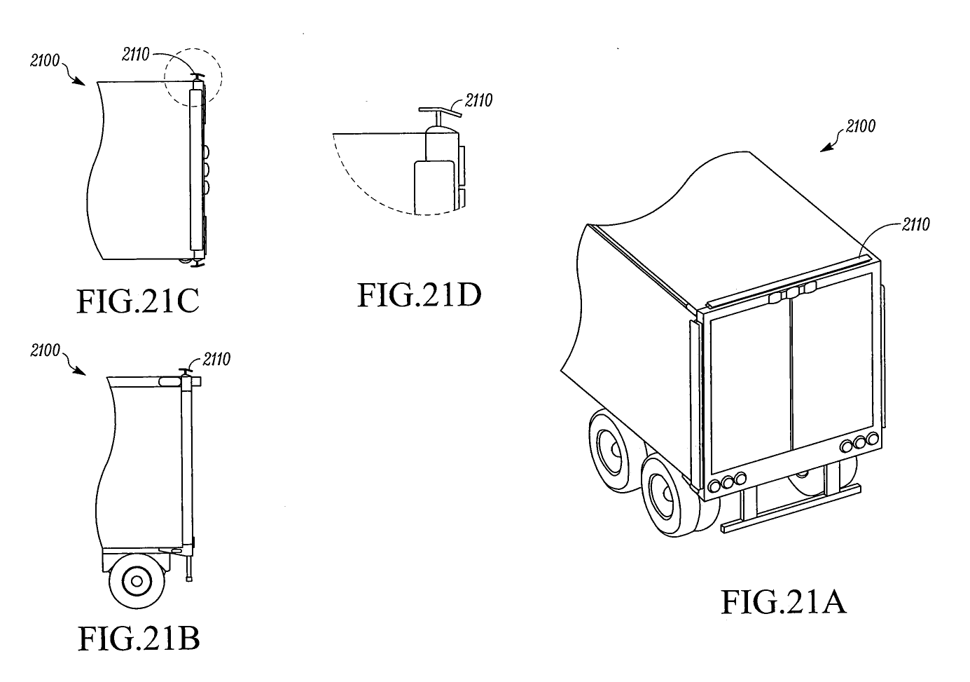

FIGS. 19A through 20D illustrate one embodiment of directing airflow by way of implementing relatively angled structures with respect to walls of the transport unit, such as for example vanes or louvers.

The transport unit 1900 can include vanes 1910 similar to those already described, but where the vanes 1910 may be transport unit door mounted, may be put into deployed and non-deployed positions, and where the transport unit includes a recessed area 1914 on the door to allow the vanes to be recessed and not protrude from the general outer/door wall structure of the transport unit 1900. FIGS. 19A through 19D show the vanes 1910 in a non-deployed position. FIGS. 20A through 20D show the vanes 1910 in the deployed position where air can flow around, along the vane 1910 structure. In some embodiments, a mechanism 1912 is used to move the vanes 1910 into/out of the deployed, non-deployed positions.

FIGS. 21A through 21D illustrate one embodiment of directing airflow by way of implementing relatively angled and/or contoured structures with respect to walls of the transport unit, such as for example baffles.

Other suitable structures that may differ from vanes or louvers may also be employed. FIGS. 21A through 21D show a transport unit 2100 with baffle structures 2110 having a certain contour and/or angle to direct flow. As shown, the baffles structures 2110 are disposed on sides and the top of the transport unit 2100 toward the rear.

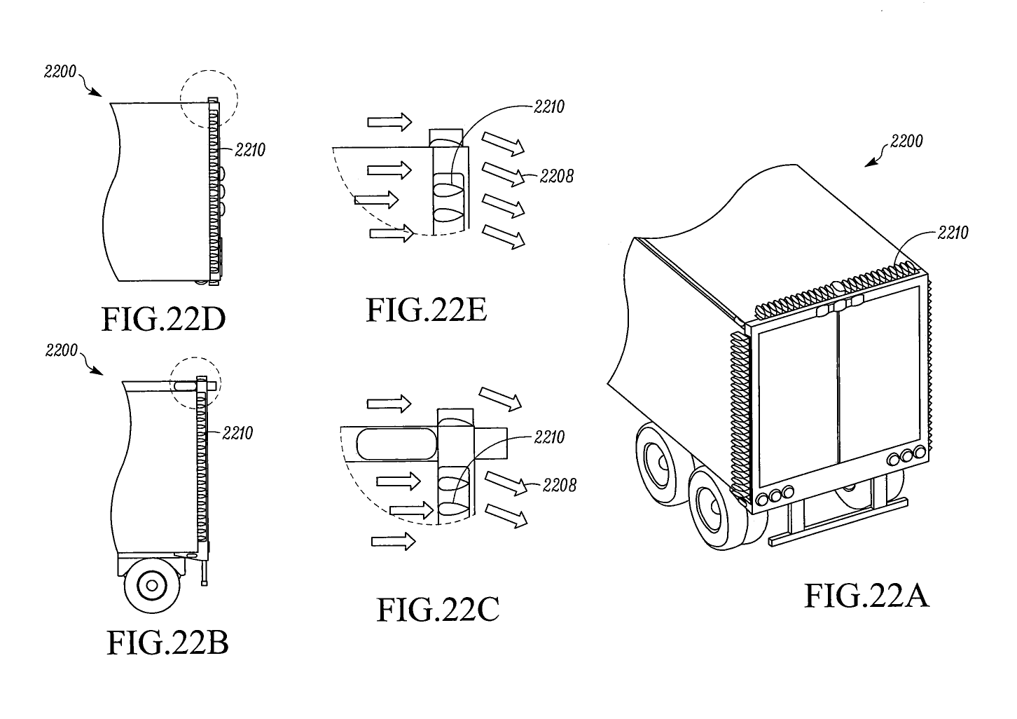

FIGS. 22A through 22E illustrate one embodiment of directing airflow by way of implementing relatively angled and/or contoured structures with respect to walls of the transport unit, such as for example fins.

Other suitable structures that may differ from vanes or louvers may also be employed. FIGS. 22A through 22E show a transport unit 2200 with fins structures 2210 having a certain contour and/or angle to direct flow (see arrows 2208). As shown, the fins 2210 are disposed on sides and the top of the transport unit 2200 toward the rear. The fins 2210 can be fixed or may be adjustable and help to direct flow such as at the sharp corners of the transport unit 2200.

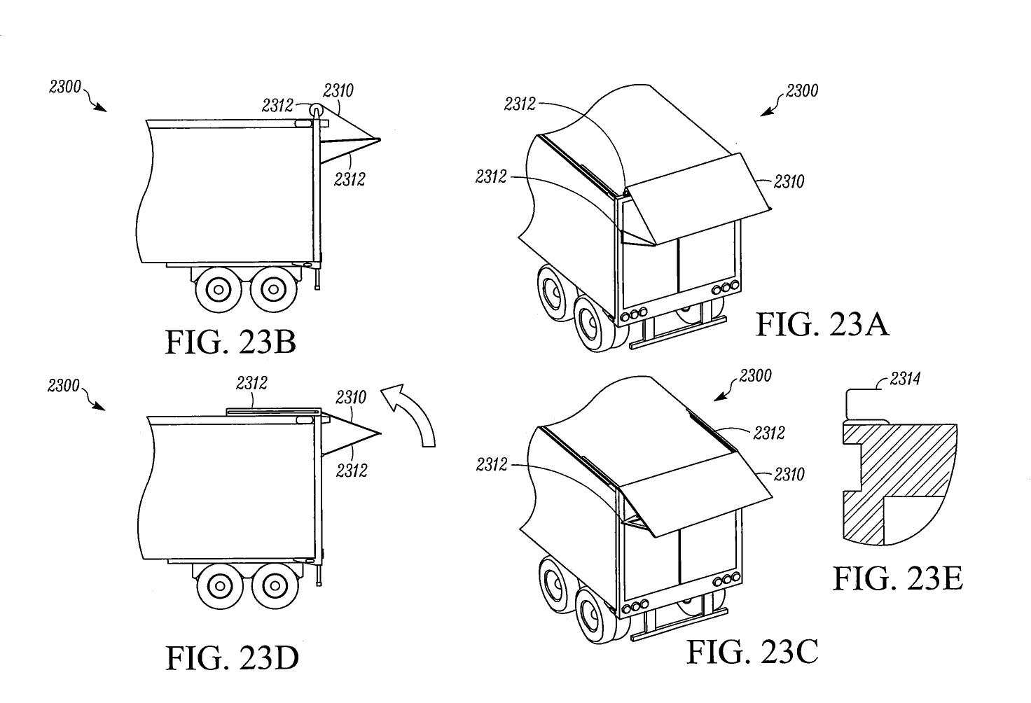

FIGS. 23A through 23E illustrate embodiments of directing airflow by way of implementing relatively angled structures with respect to walls of the transport unit, such as for example awning type structures.

Other suitable structures that may differ from vanes or louvers may also be employed. FIGS. 23A through 23E show a transport unit 2300 with an awning type structure 2310, and which can be retractable and/or adjustable. As shown, the awning structure 2310 is connected at the top of the transport unit 2300 toward the rear using a mechanism 2312. In the embodiment of FIGS. 23A and B, the awning 2310 can be a relatively flexible material and can be placed in a deployed or non-deployed position using the mechanism 2312, which can include sliding bars and a roll to allow the awning to move upward and be rolled up. In some embodiments, the flexible material can be a general extendable structure that can discharge air such as for example away from the rear doors. In some embodiments, this may be an add on type of accessory such as for example a wind sock. In the embodiment shown in FIGS. 23C through 23E, the awning 2310 can be a relatively rigid material and can employ rails to put the awning in the deployed or non-deployed positions. For example, the awning in FIGS. 23C through 23E can move upward and slide on the top of the transport unit 2300 along the rails 2314 of the mechanism (see arrows). It will be appreciated that the mechanisms 2312 are exemplary only as various other ways to move the awnings may be suitable.

It will be appreciated that the particular geometry and angling of the vanes, louvers, baffle structures, fins, and/or awning structures can be modified adjusted as desired and/or needed, and used to uniformize air flow such as at the rear of the transport unit. Further other structures such as plane or wing like flaps to move air from the bottom or top to a low pressure area.

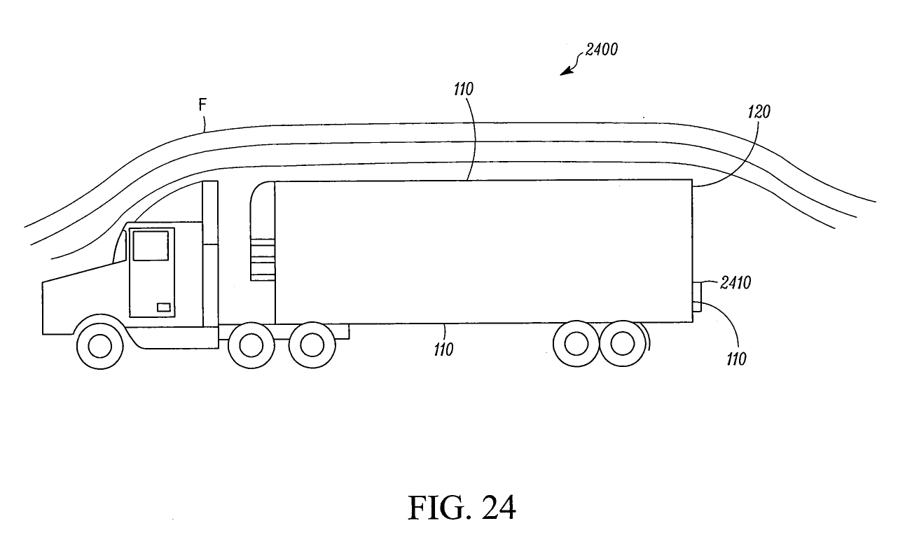

FIGS. 24 through 29 show various components, structures, mechanisms, devices, implementations and the like to direct airflow at the rear of the tractor trailer. The implementations in these drawings can counter turbulent flows and/or address low pressure area(s).

FIG. 24 illustrates one embodiment of directing airflow by way of implementing a mechanism or source to generate relatively high pressure air at the back of the tractor trailer.

FIG. 24 shows a tractor trailer 2400 with a transport unit 107 (e.g., the transport unit 107 shown in FIG. 1). The tractor trailer 2400 has a component 2410 disposed at the rear of the transport unit 107. The component 2410 can be for example a heater or cooler to cause relative expansion and/or contraction of air to counter turbulent flows and to address low pressure area(s). In some embodiments, the component 2410 may be embedded within the wall structure of the trailer, such as for example embedded within the transport unit rear door.

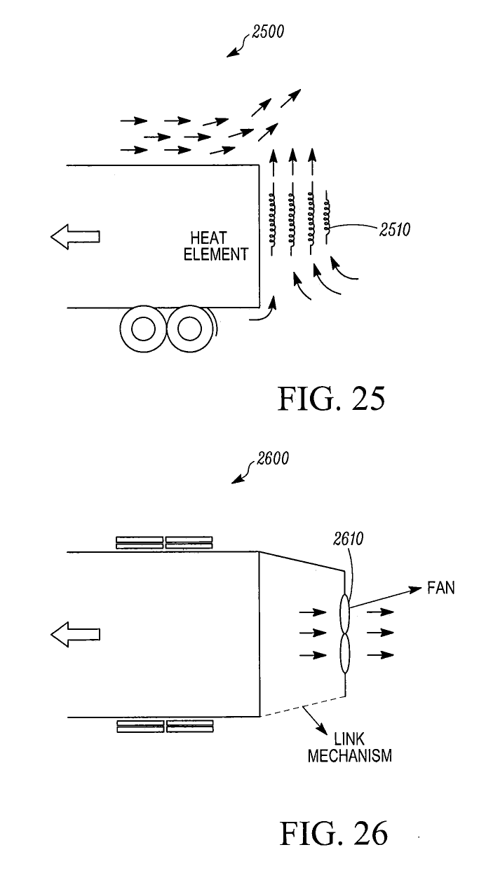

FIG. 25 illustrates one embodiment of directing airflow by way of implementing a mechanism or source to generate relatively high pressure air at the back of the transport unit, such as for example a heat source such as a heating element.

FIG. 25 shows a transport unit 2500 that can implement a heating source 2510, such as for example a heating element, a coil, and the like to cause relatively warm air to rise up and direct air passing over the top of the transport unit (see arrows). The heating source 2510 can help to address the pressure issues at the back of the transport unit 2500, e.g. to decrease pressure at the back.

FIG. 26 illustrates one embodiment of directing airflow by way of implementing a mechanism or source to generate relatively high pressure air at the back of a transport unit 2600, such as for example a fan.

FIG. 26 shows a transport unit 2600 that can implement a source of airflow, such as a dedicated source for example a fan 2610. The fan 2610 can be directed in a manner to cause an airflow in any desirable direction (e.g. upward) to address pressure issues that may occur at the rear of the transport unit (see arrows). It will be appreciated that the fan can be linked and powered appropriately.

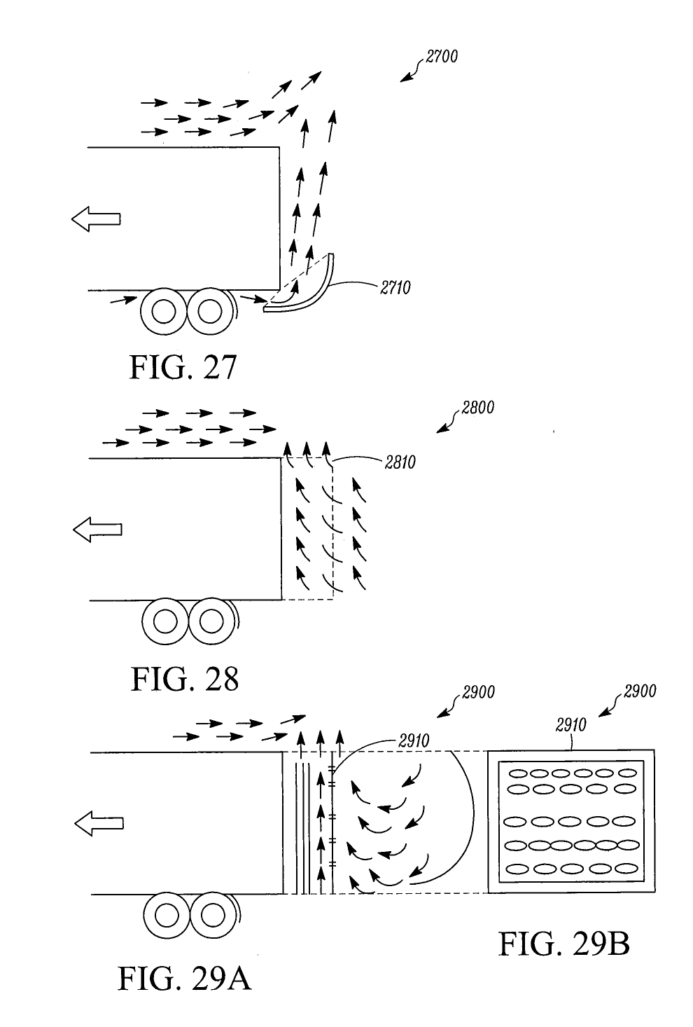

FIG. 27 illustrates one embodiment of directing airflow by way of implementing a mechanism or source to generate relatively high pressure air at the back of the transport unit, such as for example using a deflector toward the bottom of the transport unit.

FIG. 27 shows a transport unit 2700 that can implement a diverter or deflector structure 2710, such as for example a spoiler. The diverter 2710 can act a relatively sized scoop to direct air e.g. upwards (see arrows). In some embodiments, the arrangement of the diverter 2710 can be behind the wheel to help facilitate airflow generated by the wheels upward and not vortex back.

FIG. 28 illustrates one embodiment of directing airflow by way of implementing a mechanism or source to generate relatively high pressure air at the back of the transport unit, such as for example a drag deflector with vanes.

In some embodiments, a transport unit 2800 can include protruding vane structures from the rear of the transport unit 2800. FIG. 28 shows a structure 2810 that can be configured as a drag deflector with vanes. The structure 2810 can direct flow accordingly (see arrows).

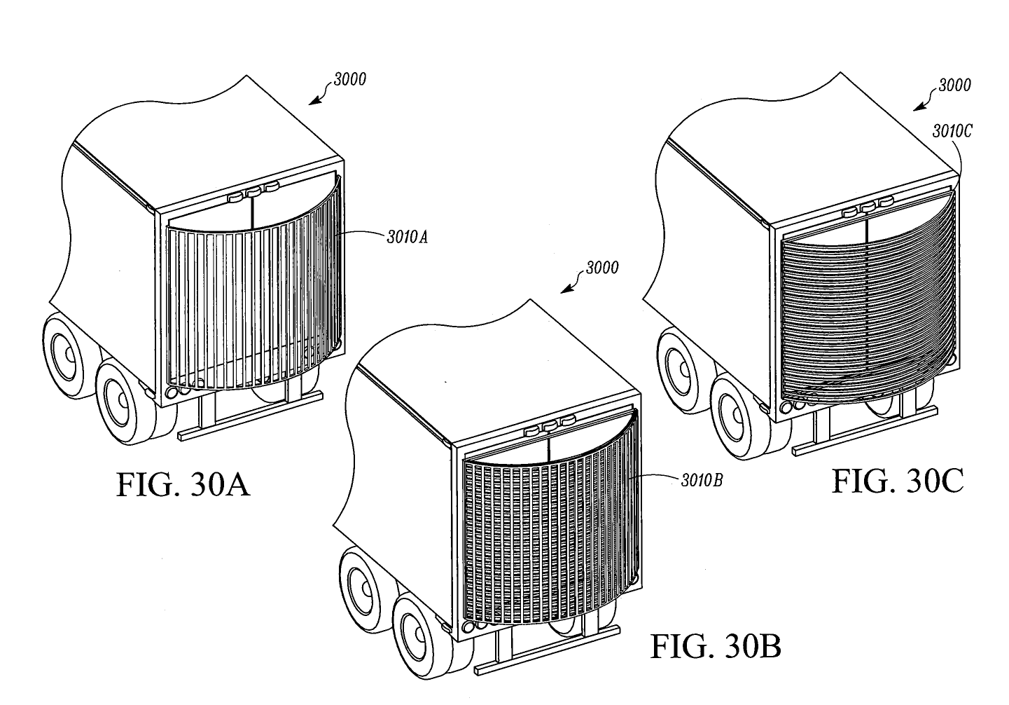

FIGS. 29A and B illustrate one embodiment of directing airflow by way of implementing a mechanism or source to generate relatively high pressure air at the back of the transport unit, such as for example using one or more plates with apertures.

In some embodiments, various types of turbulating structures may be employed to cause disruption of airflows to increase pressure. FIG. 29 shows a transport unit 2900 with a turbulating structure in the form of one or more plates with openings (e.g. perforations or apertures). The turbulating structure can increase pressure in a low pressure area, e.g. the rear of the transport unit 2900 (see arrows). As shown, the turbulating structure 2910, much like in FIGS. 5 and 6, have holes into a channel between the turbulating structure 2910 and the wall of the transport unit 2900. FIG. 29B is a rear view of the turbulating structure 2910 with an embodiment of the openings.

FIGS. 30A through 30C illustrate embodiments of directing airflow by way of implementing a mechanism or source to generate relatively high pressure air at the back of the transport unit, such as for example turbulating structures that protrude from the back of the transport unit, such as for example frames or truss type structures.

Other forms of turbulating structures are shown in FIGS. 30A through 30C. FIG. 30A shows vertical type configured turbulating structure 3010A. FIG. 30B shows a mixed vertical and horizontal type configured turbulating structure 3010B. FIG. 30C shows a horizontal type configured turbulating structure 3010C. In some embodiments, such turbulating structures, e.g. 3010A, 3010B, and 3010C resemble cage-like or truss-like structures. In some embodiments, such turbulating structures, e.g. 3010A, 3010B, and 3010C can increase pressure in low pressure area(s) and/or breakdown vortices in the airflow.

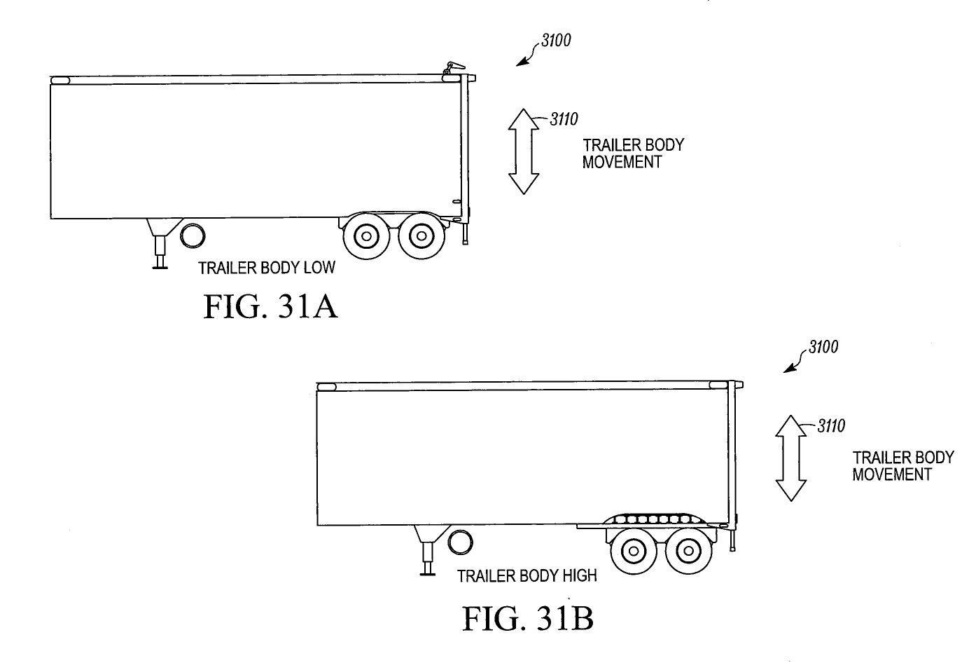

FIGS. 31A and 31B illustrate one embodiment of directing airflow by way of implementing a mechanism to vary the height of the transport unit, which can be a mechanism to assist with other airflow directing implementations.

FIGS. 31A and 31B show a transport unit 3100 with the ability to move vertically upward or downward (see arrow 3110). Such a mechanism allows accommodation of any one or more of the above airflow director implementations, such as for example to comply with certain road and/or transport regulations (e.g. Department of Transportation height limitations). FIG. 31A shows the transport unit 3100 in a relatively low ride position, and FIG. 31B shows the transport unit 3110 in a relatively higher position.

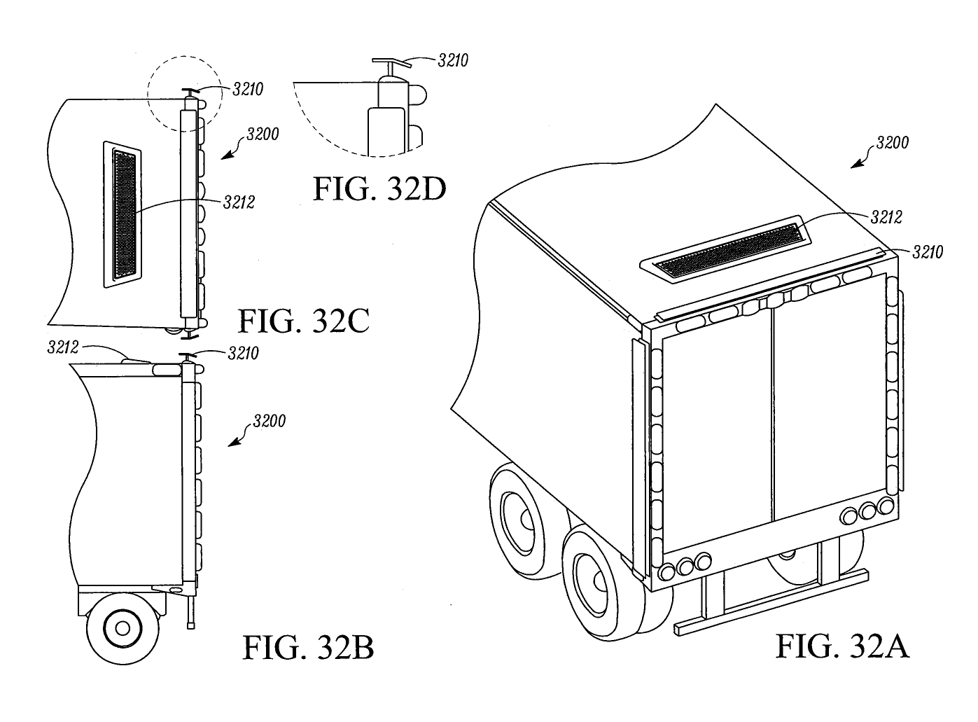

FIGS. 32A through 32D illustrate one embodiment of directing airflow by way of implementing a power source, which can be used to assist with other airflow directing implementations, such as for example to power the other airflow directing implementations.

It will be appreciated that the airflow director implementations where appropriate can be controlled and powered as desired and/or needed. For example, in the case of the adjustable vanes, the heating element, the fan, as some examples, various control systems may be employed and the implementations powered appropriately. In the example of a baffle structure 3210 as in the transport unit 3200 of the embodiment shown in FIGS. 32A through 32D, a rechargeable power source 3212, such as for example a rechargeable solar power source may be employed to deploy the baffle structure 3210. It will be appreciated that a rechargeable power source may not be employed as other suitable power sources may be used. Likewise, it will be appreciated that the power source descriptions herein can be applicable to any of the airflow director implementations described herein and that may need and/or could make use of power source.

In examples of airflow directing implementations, which involve adjustable components (e.g. adjustable vanes), mechanisms, and powered components, and the like, various controls and systems may be suitable for controlling an airflow directing implementation desired. In some embodiments, control may be based on various inputs, such as for example but not limited to using pressure readings (e.g. negative pressure) and/or speed, relative readings thereof, and the like. It will be appreciated that control systems, control implementations, schemes, and the like can be suitably applied to the airflow director implementations described herein, and may for example incorporate disclosure concepts from US Provisional Application 62/098652, filed on the same date as the instant application, and which is herewith incorporated by reference in its entirety.

It will be appreciated that any of the air flow directing implementations, which include various structures, such as for example channeling, vanes, louvers, baffles, slots, recesses, openings, end structures (e.g. scoops), and the like may implemented as add on type accessories, through the use of a separate skin, and/or implemented within the wall structure of the tractor trailer.

It is to be appreciated that the specific geometries, dimensions, angles, etc. for any of the airflow director implementations herein can be optimized by, for example, using various fluid dynamics studies and/or testing, such as for example by using various models which may include computational fluid dynamics (CFD) analysis.

It is to be appreciated that embodiments as disclosed herein may be made as a retrofit kit to modify existing components of a tractor trailer and transport unit. It will be appreciated that control systems, control implementations, schemes, and the like can be suitably applied to the airflow director implementations described herein, and may for example incorporate concepts discussed with respect to Part IV below.

### Part II: Airflow Director Cont'd

A transport unit (e.g. a temperature controlled transport unit), such as a truck trailer, a shipping container, etc., may be transported by, for example, a tractor, a train, etc. When the transport unit is in motion, the tractor and the transport unit may create aerodynamic drag, which may reduce, for example, fuel economy of the tractor.

References are made to the accompanying drawings that form Part II hereof, and in which is shown by way of illustration of the embodiments in which the embodiments of Part II may be practiced. It is to be understood that the terms used herein are for the purpose of describing the figures and embodiments of Part II and should not be regarded as limiting the scope.

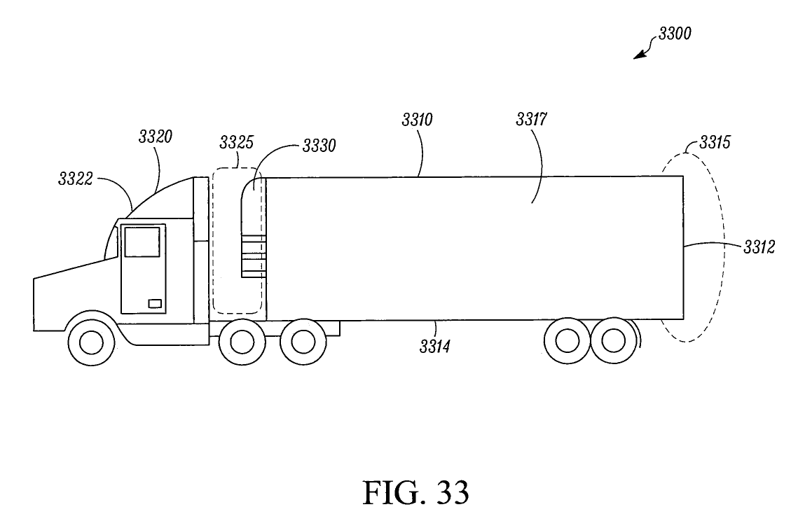

FIG. 33 illustrates a temperature controlled transport unit 3300, which includes a transport unit 3310 transported by a tractor 3320. When in motion, aerodynamic drag may be created at, for example, a front side 3322 of the tractor 3320, a gap 3325 between the tractor 3320 and the transport unit 3310, an area 3315 proximity to a back side 3312 of the transport unit 3310, and/or a bottom 3314 of the transport unit 3310 and/or the tractor 3320. The aerodynamic drag can create air resistance, which may reduce fuel economy of the tractor 3320 in motion. A TRU 3330 is provided at a front end of the transport unit 3310 within the gap 3325.

The TRU 3330 can be used to help regulate a temperature of a space 3317 (e.g., a cargo space, an interior space, etc.) (generally referred to as a “conditioned space”) of the transport unit 3310.

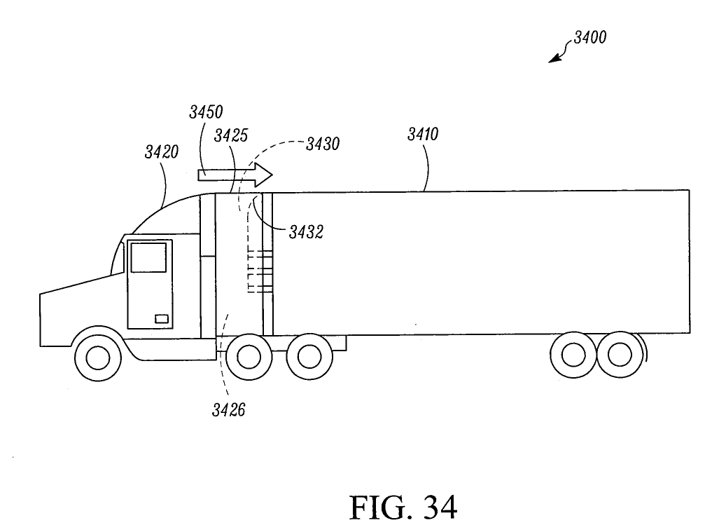

Various systems, methods and apparatuses may be used to reduce aerodynamic drag. For example, FIG. 34 illustrates a temperature controlled transport unit 3400 with an aerodynamic faring (e.g. an aerodynamic shell) 3440 may be used to substantially cover a gap 3425 between a tractor 3420 and a transport unit 3410. The aerodynamic faring 3440 may help streamline an aerodynamic surface at the gap 3425, which can help reduce, for example, aerodynamic drag created due to the gap 3425.

A TRU 3430 can be optionally provided in the gap 3425. The optional TRU 3430 can include a vapor-compression type refrigeration system, which may generally include a compressor, a condenser, an expansion device and an evaporator (not shown). The condenser of the optional TRU 3430 can be air cooled by one or more condenser fans. When the optional TRU 3430 is positioned in the gap 3425, the condenser fan may pick up air in the gap 3425 and circulate the air through the condenser to remove heat.

One issue associated with using the aerodynamic faring 3440 is that the aerodynamic faring 3440 may impact the airflow provided by the condenser fan of the optional TRU 3430. For instance, the aerodynamic faring 3440 may create an airstream 3450 through a top side 3432 of the optional TRU 3430. Because the optional TRU 3430 may have an airflow exit (not shown) on a top side 3432 of the optional TRU 3430, the airstream 3450 may negatively impact the rejection of air by the condenser fan at the top side 3432 of the optional TRU 3430.

In some situations, the use of the aerodynamic faring 3440 may also create a relatively low pressure zone 3426 in the gap 3425. The relatively low pressure zone may negatively impact the condenser fan on picking up air in the gap 3425.

Embodiments configured to help improve an airflow through, for example, a condenser fan of the TRU unit (e.g. the TRU unit 3430) may generally configured to direct an airflow toward a gap where the TRU unit is located. When, for example, the aerodynamic faring is used, the airflow directed to the gap may help overcome the negative impacts on the operation of the TRU by the aerodynamic faring. Generally, the embodiments configured to help direct an airflow toward the gap may include surface features, such as one or more openings, louvers, tunnels, baffles, air directors, deflectors, inverters, etc. that are strategically arranged or positioned on the tractor, the transport unit, and/or the aerodynamic faring.

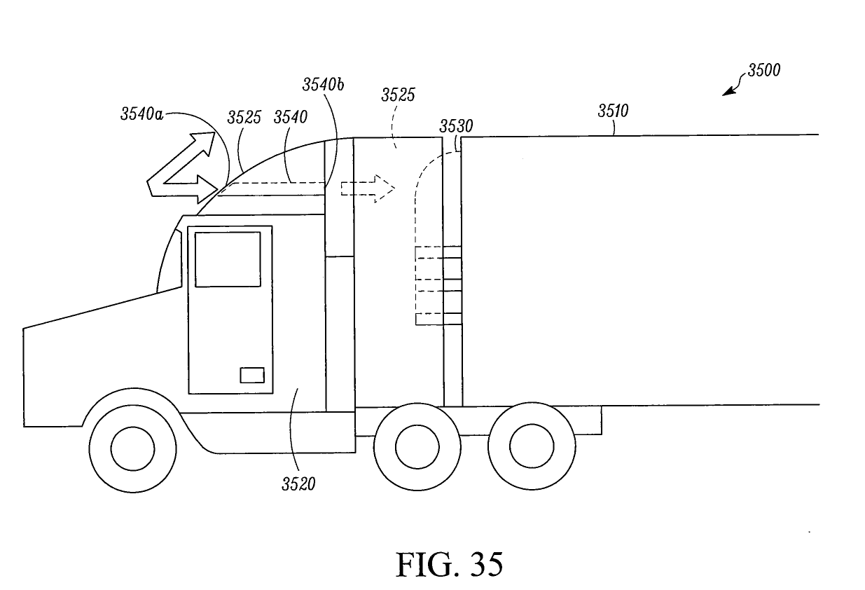

The airflow directed to the gap between the tractor and the transport unit may have various sources. FIG. 35 illustrates one embodiment of a temperature controlled transport unit 3500 that is configured to source the airflow from a front side 3522 of a tractor 3520. The tractor 3520 can be used to transport a transport unit 3510, which can be equipped with an optional TRU 3530.

When the tractor 3520 is in motion, the front side 3522 can push against atmosphere, causing a relatively high pressure. Generally, methods, systems and apparatuses can be configured to direct air from the front side 3522 with the relatively high pressure to a gap 3525 between the tractor 3520 and a transport unit 3510.

As illustrated in FIG. 35, an upper portion 3525 of the tractor 3520 (e.g. a wind deflector in some embodiments) may be configured to include a passage 3540 to direct air from the front side 3532 toward the gap 3525. The passage 3540 can include a first opening 3540a that is opened toward the front side 3522 of the tractor 3520, and a second opening 3540b that is opened toward the gap 3525. The first opening 3540a may be configured to receive the air with the relatively high pressure when the tractor 3520 is in motion, and direct the air toward the second opening 3540b to release the air into the gap 3525.

It is to be appreciated that in some embodiments, for example in some wind deflectors, the upper portion 3525 may be a shell-like structure. In these embodiments, the passage 3540 may only include the first opening 3540a, as the shell-like structure can allow air to flow from the front side 3522 into the gap 3525.

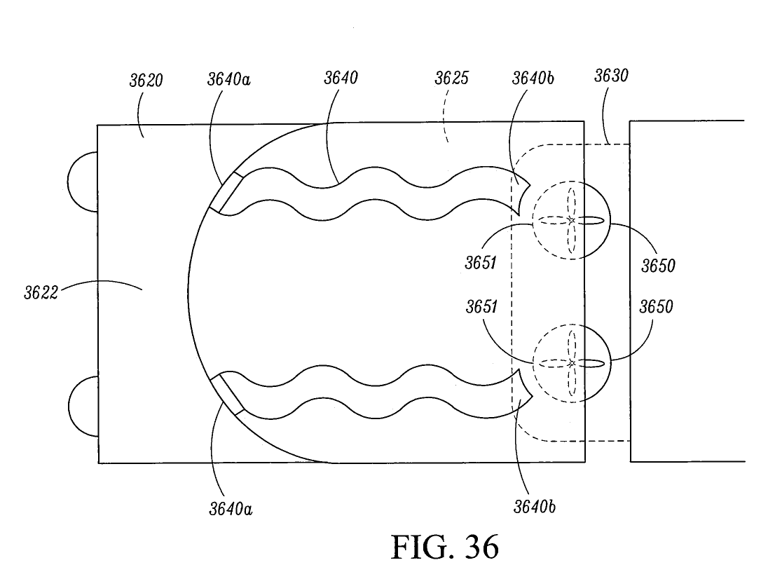

It is to be appreciated that the passage 3540 as illustrated is exemplary. The configuration of the passage 3540 (e.g., dimensions, sizes, shapes, curvatures, etc.) can be varied. It is also to be appreciated that the first opening 3540a and/or the second opening 3540b can be located at different locations. In some embodiments, the passage 3540 can be configured to direct air to a desired location within the gap 3525, such as for example, an area close to an inlet of a condenser fan of the optional TRU 3530. FIG. 36, which will be described in detail below, is directed to one example of an airflow passage 3640 configured to direct air toward an inlet of a condenser.

When in motion, the passage 3540 can help form a fluid communication between the front side 3522 of the tractor 3520, which may have the relatively high pressure, and the gap 3525, which may have a relatively low pressure. Due to the pressure difference, airflow can be directed toward the gap 3525, resulting a relatively increased pressure in the gap 3525 compared to a configuration without the airflow passage 3540. The increased pressure in the gap 3525 can help the operation of the optional TRU unit 3530 located in the gap 3525.

FIG. 36 illustrates one embodiment of passages 3640 that are configured to direct airflow toward an inlet 3651 of a condenser fan 3650. In the illustrated embodiment, a TRU 3630 is configured to include two condenser fans 3650, with the appreciation that the number of the condenser fans 3650 is exemplary and can be varied.

The passages 3640 are configured to direct air from a first opening 3640a toward a second opening 3640b. The first opening 3640a can be configured to receive air from a front side 3622 of a tractor 3620. The second opening 3640b can be positioned in proximity with the inlet 3651 of the condenser fan 3650. It is appreciated that the second opening 440b can also be coupled to the inlet 3651 directly.

The passages 3640, in some embodiments, can be made of a flexible or fabric-like material (e.g., nylon, polyurethane, cotton, etc.). When a tractor is in motion, the flexible or fabric-like material of the passages 3640 can be inflated by an air pressure. In some embodiments, the material of the passage can be stretchable or overly long to, for example, compensate for turning of the tractor 3620.

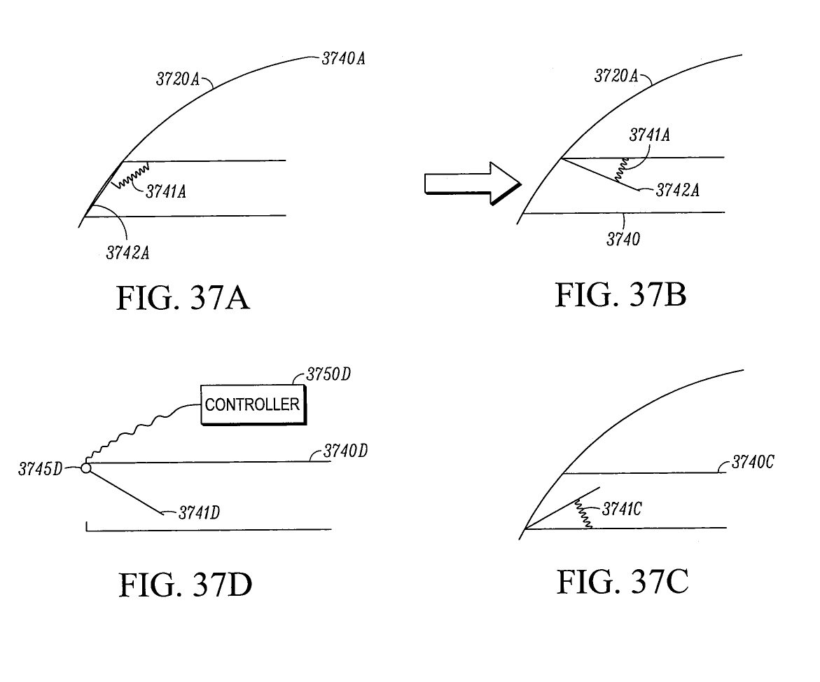

Referring to FIGS. 37A to 37D, exemplary embodiments of a first end of a passage to direct airflow are described. Generally, the first end of the passage may be configured to have an open state and a closed state, where the open state allows an airflow to get into the passage and the closed state generally prevent an airflow getting into the passage.

As illustrated in FIGS. 37A and 37B, a first end 3740A can include a shutter 3742A with a force-loaded device 3741A (e.g. a spring). When a tractor 3720A is stationary, the shutter 3742A can be at a closed state, pushed by the force-loaded device 3741A, which generally prevents air from getting into a passage 3740A.

When the tractor 3720A is in motion, as illustrated in FIG. 37B, an air pressure generated by the motion of the tractor 3720A can help push the shutter 3741A open against the force-loaded device 3741A. The force-loaded device 3741A can be configured, for example, to open when the tractor 3720A reaches a desired speed.

In FIGS. 37A and 37B, the force-loaded device 3741A is mounted to an upper portion of the passage 3740A. This is exemplary. The force-loaded device can have other configurations. For example, as illustrated in FIG. 37C, in some embodiments, a force-loaded device 3741C can be mounted to a lower portion of a passage 3740C.

In some other embodiments, such as for example as illustrated in FIG. 5D, an opening/closing device 3741D (e.g. a shutter) can be actuated by an actuator 3745D that may be controlled by a controller 3750D. The opening/closing device 3741D of a passage 3740D can have an open state and a closed state that are controlled by the controller 3750D.

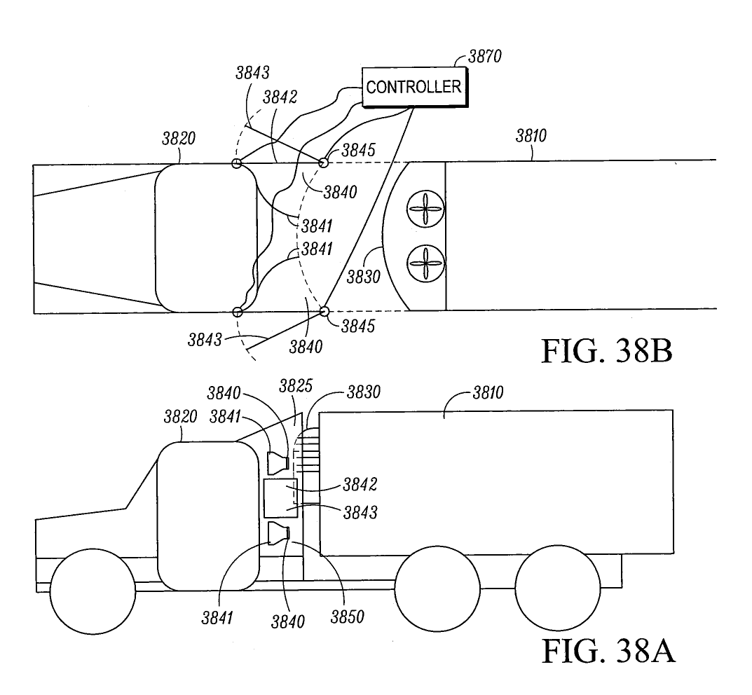

FIGS. 38A and 38B illustrate another embodiment configured to direct air into a gap 3825 between a tractor 3820 and a transport unit 3810. In the illustrated embodiment, to reduce aerodynamic drag, the gap 3825 is at least partially covered by an aerodynamic shell 3850. The aerodynamic shell 3850 can create a relatively low pressure in the gap 3825, which may affect performance of a TRU 3830.

The aerodynamic shell 3850 can be configured to have one or more openings 3840, 3842 to allow airflow into the gap 3825. Airflow into the opening 3840 can be directed by a fixed type baffle 3841. A fixed type baffle is generally referred to a baffle that typically does not vary the configuration in operation. As illustrated in FIG. 38B, the fixed type baffle 3841 may be shaped to have a smooth curve so as to direct the airflow as desired. In some embodiments, the fixed type baffle 3841 may be shaped to direct airflow toward, for example, a condenser fan inlet of the TRU 3830.

In the illustrated embodiment, the fixed type baffle 3841 defines the opening 3840 to the gap 3825. When in motion, airflow can get into the gap 3825 through the opening 3840.

The opening 3842 may be covered by an adjustable type baffle 3843. An adjustable type baffle is generally referred to as a baffle having a configuration that can be varied in operation.

As illustrated in FIG. 38B, the adjustable type baffle 3843 can be equipped with an actuation device 3845 that is configured to, for example, open or close the adjustable type baffle 3843. The actuation device 3845 may be controlled, for example, by a controller 3870.

In operation, the actuation device 3845 may open or close the adjustable type baffle 3843, which can result in a variable amount of airflow into the gap 3825 through the opening 3842. The adjustable type baffle 3843 can be adjusted, for example, based on a speed of the tractor 3820, an airflow demand of the TRU 3830, an ambient temperature, a temperature of the TRU 3830, etc.

It is to be appreciated that the openings can be positioned at various sides of the aerodynamic shell 3850 (e.g. left and/or right sides, top side, etc.).

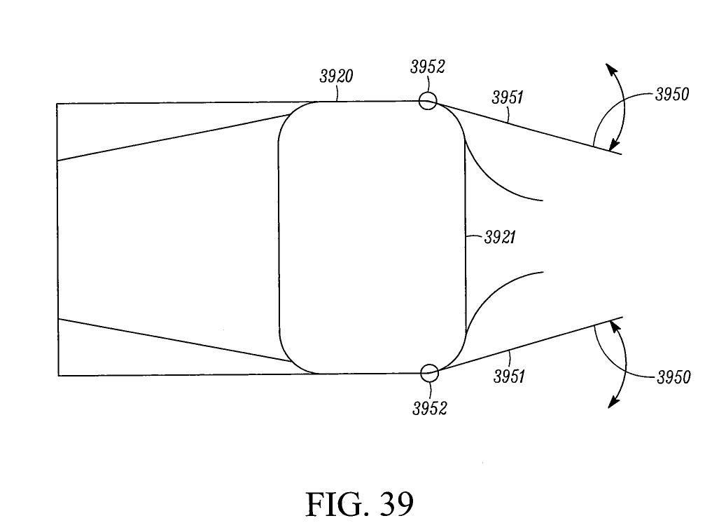

FIG. 39 illustrates that an aerodynamic shell 3950 can include adjustable sides 3951 in some embodiments. The adjustable sides 3951 can, for example, be equipped with actuators 3952 configured to adjust positions of the adjustable sides 3951. For example, the adjustable sides 3951 can swing relative to a tractor 3920.

The adjustable sides 3951 of the aerodynamic shell 3950 can swing inwardly relative to the tractor 3920 toward a back 3921 of the tractor 3920. Swinging the adjustable sides 3951 toward the back 3921 may help reduce an aerodynamic drag when the tractor 3920 does not tow a transport unit. The adjustable sides 3951 can also swing outwardly relative to the tractor 3920 away from the back 3921. Swinging the adjustable sides 3951 away from the back 3921 may, for example, help in coupling a transport unit to the tractor 3920. The adjustable sides 3951 can also help achieve a desired aerodynamic profile for the aerodynamic shell 3950 during operation. For example, the desired aerodynamic profile for the aerodynamic shell 3950 may vary depending on a speed of the tractor 3920, an ambient temperature, a condenser fan speed, etc.

It is to be appreciated that embodiments as disclosed herein may be made as a retrofit kit to modify existing components of a tractor and transport unit (e.g. an aerodynamic shell, a wind deflector, etc.).

It will be appreciated that control systems, control implementations, schemes, and the like can be suitably applied to the airflow director implementations described herein, and may for example incorporate concepts discussed with respect to Part IV below.

### Part III: Aerodynamic Tail

With respect to Part III, a transport unit generally refers to an apparatus or system that can be used to transport a cargo, e.g. a truck, a trailer, a container, a train, an airplane, or a ship. In some transport units that may move in a relatively high speed (e.g. 60 mph or above), such as a truck or a trailer, movements of the transport units may result in increased aerodynamic resistance (e.g. aerodynamic drag) and decreased fuel efficiency. It is desirable to reduce the aerodynamic resistance when the transport unit is in motion.

The embodiments described herein are related to a deployable aerodynamic tail of a transport unit that can be configured to modify an overall aerodynamic profile of the transport unit when deployed. In deployment, the aerodynamic tail can help reduce, for example, an aerodynamic drag of the transport unit when the transport unit is in motion. In some embodiments, the aerodynamic tail can be configured to direct an airflow to a relatively low pressure region at a rear end of the transport unit when the transport unit is in motion. In some embodiments, the aerodynamic tail can be configured to reduce or eliminate the relatively low pressure region. In some embodiments, the aerodynamic tail can be deployed when the transport unit is in motion, and can be folded when the transport unit is stationary. In some embodiments, the aerodynamic tail can be deployed by, for example, air. In some embodiments, the aerodynamic tail of the transport unit may be stored within a rear door structure of the transport unit when in a folded state.

References are made to the accompanying drawings that form Part III hereof, and in which is shown by way of illustration of the embodiments in which the embodiments of Part III may be practiced. It is to be understood that the terms used herein are for the purpose of describing the figures and embodiments of Part III and should not be regarded as limiting the scope.

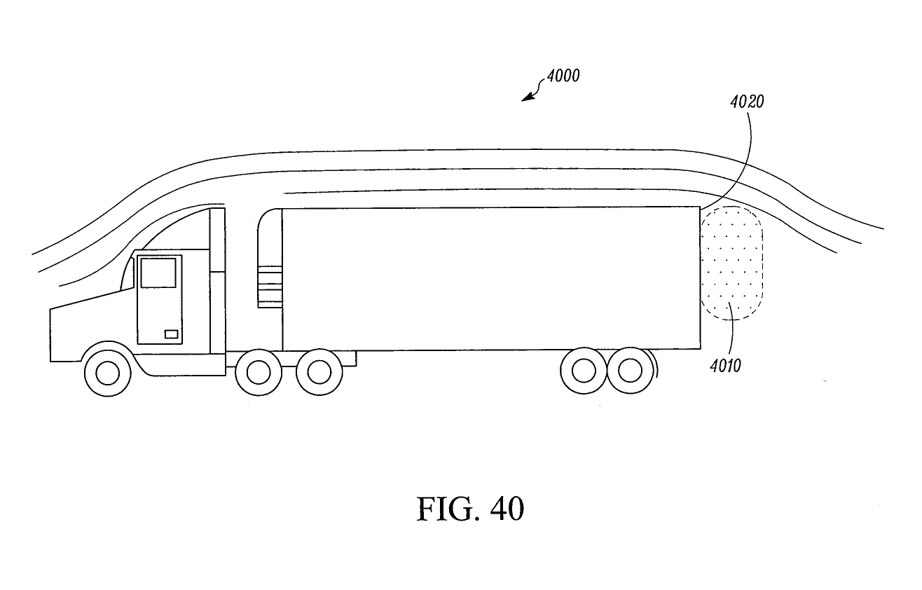

Referring to FIG. 40, when a transport unit 4000 is in motion, a relatively low pressure region 4010 may form near a rear end 4020 of the transport unit 4000. The relatively low pressure region 4010 can cause aerodynamic drag, resulting in, for example, reduced fuel efficiency. Systems, apparatus and methods directed to reduce or eliminate the relatively low pressure region 4010 can help reduce the aerodynamic drag, resulting in increased fuel efficiency.

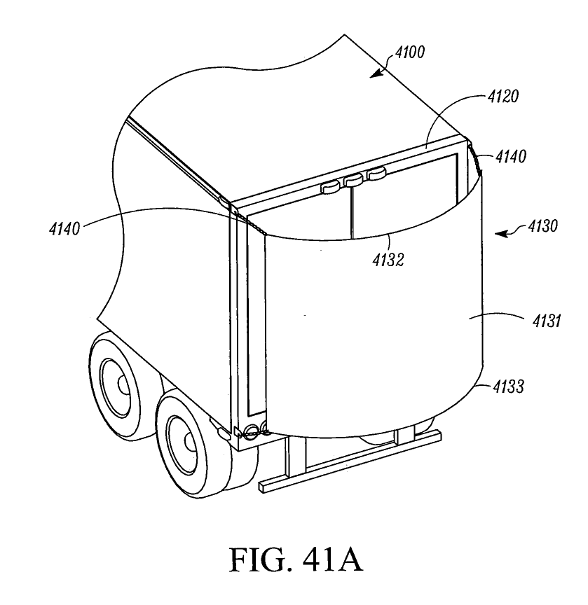

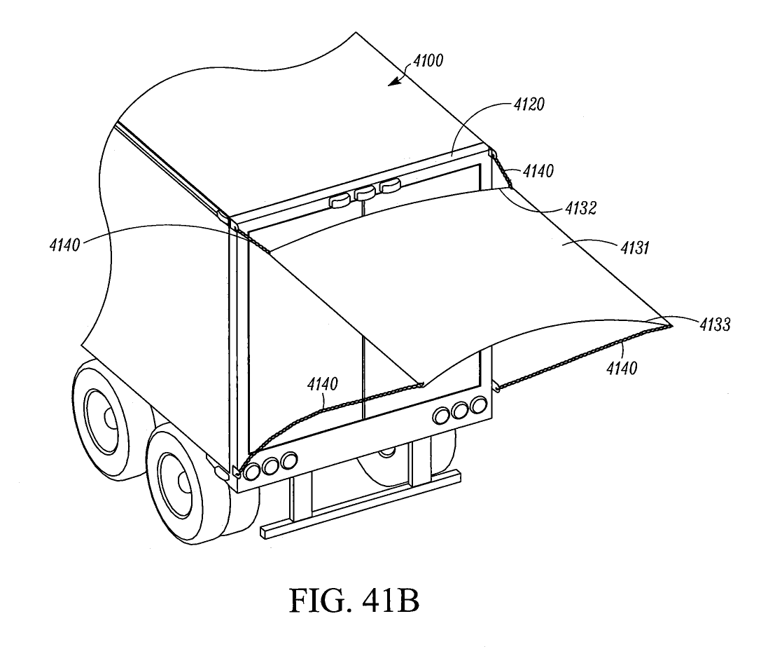

FIGS. 41A, 41B, 42 and 43 illustrate embodiments of a deployable aerodynamic tail that can be configured to direct air toward a relatively low pressure region (e.g. the relatively low pressure region 4010 shown in FIG. 40) when a transport unit is in motion, which can help increase an air pressure in the relatively low pressure region so as to reduce aerodynamic drag. A general structure illustrated herein resembles a kite, a chute, or a windsock that can be deployed by an airflow generated, for example, when the transport unit is in motion. The aerodynamic tail can be stored, for example, in a rear door structure when the aerodynamic tail is in a folded state. Generally, the aerodynamic tail illustrated in this disclosure may be made by a flexible material, such as nylon, cotton. It is to be appreciated that the aerodynamic tail can also include one or more rigid members to help maintain the structure.

FIG. 41A and 41B illustrate an aerodynamic tail 4130 of a transport unit 4100 in a deployed state, which includes a parachute-like structure 4131. A parachute-like structure generally requires an airflow for deployment and maintaining a profile. The parachute-like structure can generally be deployed when the transport unit 4100 is in motion. The parachute-like structure 4131 can be made of a flexible material, with the appreciation that the parachute-like structure 4131 may also include rigid structure members that may help the aerodynamic tail 4130 achieve a desirable configuration, and/or help fold the aerodynamic tail 4130 in a folded state.

The aerodynamic tail 4130 is attached to a rear end 4120 by one or more attachment links 4140. In some embodiments, such as illustrated, the attachment links 4140 can include a flexible element (e.g. a string, a chain, etc.) and be relatively flexible. In some embodiments, the attachment links 4140 can be relatively rigid.

When the transport unit 4100 is in motion, an airflow generated by the motion of the transport unit 4100 can help push the parachute-like structure 4131 in a direction that is opposite to the direction of the motion of the transport unit 4100, causing the aerodynamic tail 4130 to be in a deployed state. In the deployed state, the parachute-like structure 4131 can help direct air toward a relatively low pressure near the rear end 4120 of the transport unit 4100.

The configuration (e.g. shape in the deployed state, dimension, etc.) of the aerodynamic tail 4130 can be modified. In the embodiment as illustrated in FIG. 41A, the parachute-like structure 4131 can be configured to cover a substantial part of the rear end 4100 of the transport unit when deployed. Relative positions of a first side 4132 and a second side 4133 of the parachute-like structure 4131 may be relatively vertical with respect to the ground when deployed.

In the embodiment as illustrated in FIG. 41B, the parachute-like structure 4131 can be configured to cover a relatively small part of the rear end 4120 of the transport unit 4100, or not cover the rear end 4120 of the transport unit 4100 at all when deployed. When deployed, relative positions of the first side 4132 and the second side 4133 of the parachute-like structure 4131 may be relatively horizontal. In some embodiments, relative positions of the first side 4132 can be higher than the second side 4133 in the vertical direction.

Referring to FIGS. 41A and 41B together, the configuration of the aerodynamic structure 4130 can be modified, for example, by varying a length of the one or more attachment links 4140. In some embodiments, the configuration of the aerodynamic structure 4130 can also be modified by varying the length of the attachment links 4140, and/or locations on the rear end 4120 to which to which the attachment links 4140 are attached. In some embodiments, the deployed aerodynamic structure 4130 can be configured to direct at least an airflow toward a relatively low pressure zone (e.g. the relatively low pressure zone 4010 shown in FIG. 40) when the transport unit 4100 is in motion.

When the aerodynamic structure 4130 is in a folded state (e.g. when the transport unit 4100 is not in motion), the aerodynamic structure 4130 may be folded, or left to hang on the rear end 4120 of the transport unit 4100.

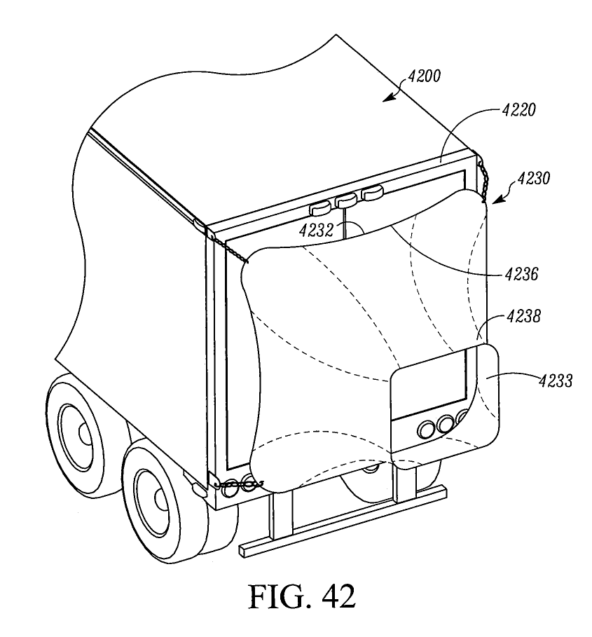

FIG. 42 illustrates an aerodynamic tail 4230 in a deployed state, which includes a conical-shaped aerodynamic structure. The aerodynamic tail 4230 is attached to a rear end 4220 of a transport unit 4200, and has a first opening 4232 on a peak 4236 of the aerodynamic tail 4230 and a second opening 4233 on a bottom 4238 of the conical-shaped structure. Generally, the first opening 4232 is larger than the second opening 4233.

When deployed, the second opening 4233 can receive an airflow created by the motion of the transport unit 4200. The airflow is directed from the second opening 4233 toward the first opening 4232. Because the first opening 4232 is relatively smaller than the second opening 4233, the aerodynamic tail 4230 can help increase a pressure in an area that is covered by the aerodynamic tail 4230 (e.g. an area corresponding to the relatively low pressure zone 4010 shown in FIG. 40) when the transport unit 4200 is in motion. The profile of the deployed aerodynamic tail 4230 may also help create, for example, a streamlined aerodynamic surface, to direct the airflow on an outer surface 4234 of the aerodynamic tail 4230.

It is to be appreciated that in some embodiments, the aerodynamic tail 4230 may not include an opening (e.g. the first opening 4232) on the peak 4236 of the aerodynamic tail 4230. The dimensions and shapes of the first opening 4232 and the second opening 4233 can be varied to satisfy, for example, different design/performance requirements.

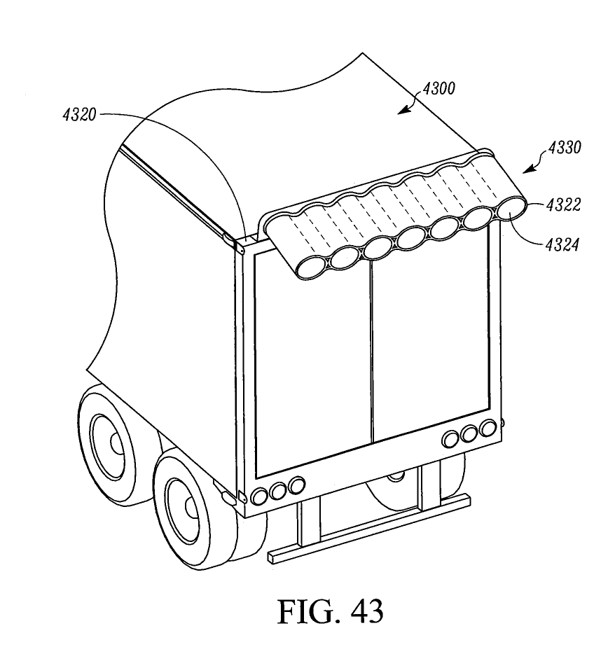

FIG. 43 illustrates an aerodynamic tail 4330 in a deployed state, which includes one or more windsock-like structures 4322. Each of the one or more windsock-like structures 4322 includes a hollow channel 4324 that is configured to direct an airflow therethrough.

In the deployed state, an airflow created by a motion of a transport unit 4300 may be directed by the hollow channels 4324 toward, for example, a relatively low pressure zone (e.g. the relatively low pressure zone 4010 in FIG. 40).

In the illustrated embodiment, the aerodynamic tail 4330 is attached near a top of a rear end 4320 of the transport unit 4300. This is exemplary. In some embodiments, the aerodynamic tail 4330 can be attached to the transport unit 4300 at other locations.

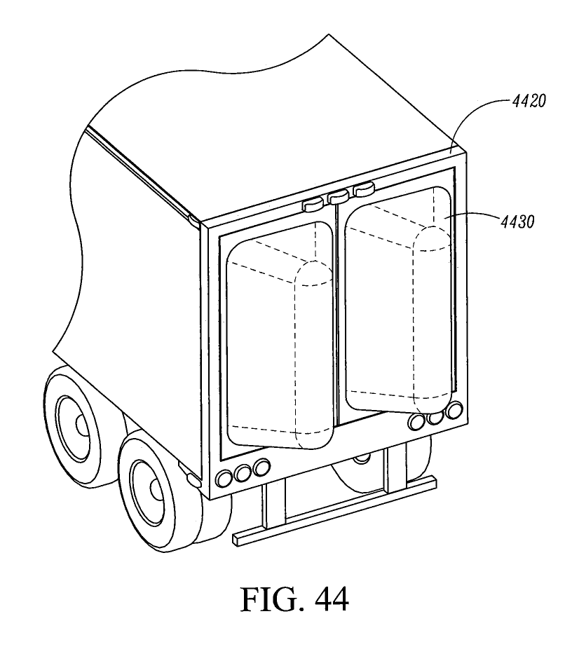

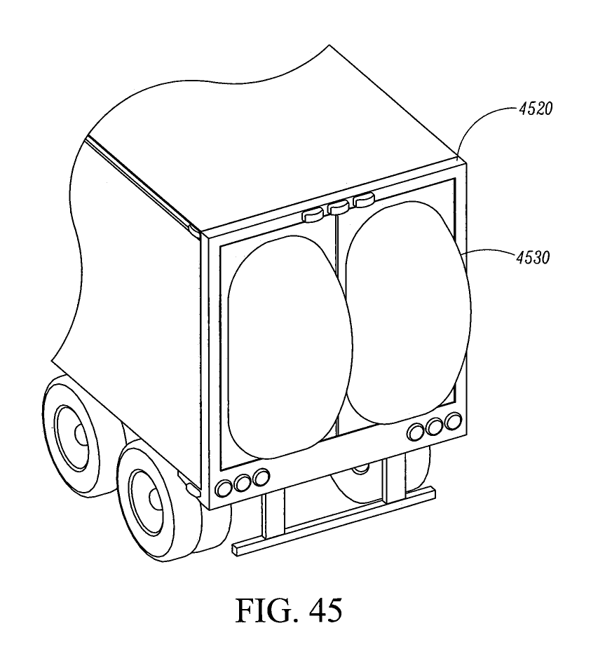

FIGS. 44-48B illustrate embodiments of inflatable aerodynamic tails, at least part of which include an inflatable structure. The term “inflatable structure” generally refers to a structure configured to receive and at least temporally hold a fluid (e.g. air), and a configuration of the structure can be modified (e.g. expanded) by the received fluid. In some embodiments, the entire aerodynamic tail may be an inflatable structure. In some embodiments, the configuration of the inflatable aerodynamic tail can be switched between an inflated state and a deflated state by directing a fluid into or out of the inflatable structure(s) of the inflatable aerodynamic tail respectively.

Generally, the inflatable aerodynamic tail may be attached to a rear end of a transport unit. When the aerodynamic tail is inflated, a profile of the inflatable aerodynamic tail may help displace a relatively low pressure area (e.g. the low pressure area 4010 in FIG. 40) created by a motion of the transport unit, and/or direct an airflow toward the relatively low pressure area.

As illustrated in FIGS. 44 and 45, an entire structure of an aerodynamic tail 4430 or 4530 can be made of an elastic and/or stretchable material, and the entire structure can be inflatable. In an inflated state as shown in FIG. 44 or FIG. 45, the aerodynamic tail 4430 or 4530 extend away from a rear end 4420, 4520 of a transport unit 4400, 4500 respectively.

In the embodiment as shown in FIG. 44, a cross section of the aerodynamic tail 4430 resembles a triangle in the inflated state. In the embodiments as shown in FIG. 45, an external profile of the aerodynamic tail 4530 resembles a dome. It is to be appreciated that the profile and configuration of the aerodynamic tail can be optimized by, for example, a computational fluid dynamics (CFD) analysis.

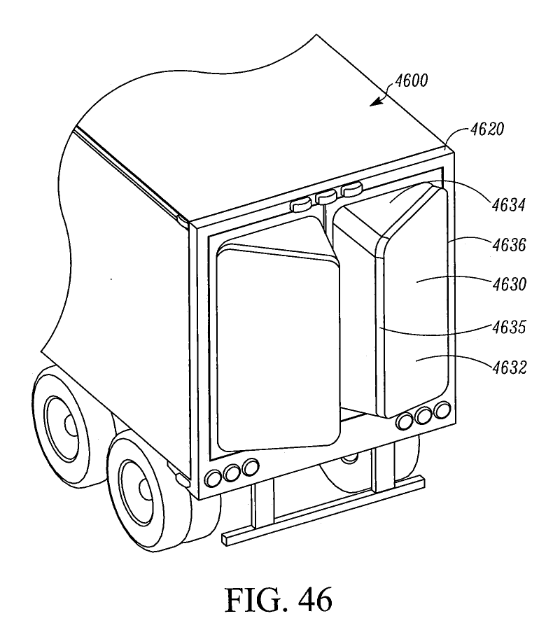

As illustrated in FIGS. 46, 47, 48A and 48B, a structure of an aerodynamic tail 4630, 4730 or 4830 can include both an inflatable structure and a relatively non-inflatable structure. The relatively non-inflatable structure typically is a structure that does not expand during deployment of the aerodynamic tail, which may include, for example, a relatively rigid structure member (a solid structure member), or a relatively non-stretchable structure member (e.g. a steal wire). The relatively non-inflatable structure can work together with the inflatable structure to, for example, shape an external profile of the aerodynamic tail in the inflated state. The relatively non-inflatable structure may also help protect the inflatable structure.

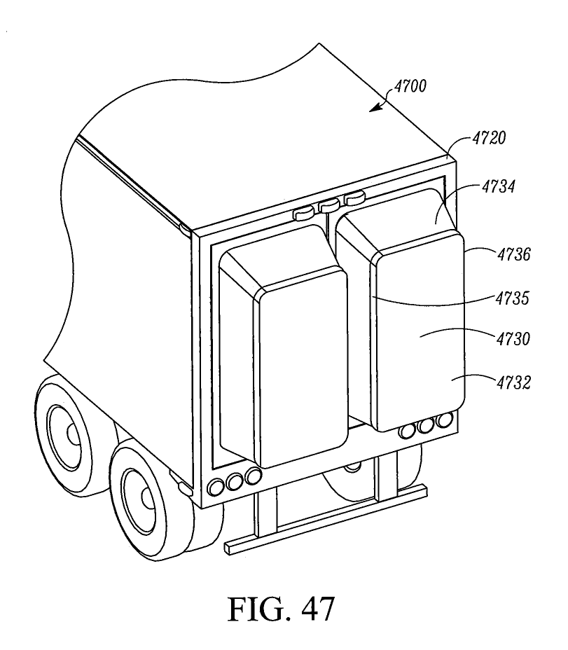

Referring to FIGS. 46 and 47, the aerodynamic tail 4630, 4730 can include a combination of a relatively solid portion 4632, 4732, and an inflatable portion 4634, 4734 respectively. When the inflatable portion 4634, 4734 is inflated by receiving a fluid (e.g. air), the solid portion 4632, 4732 can be pushed away from a rear end 4620, 4720 of a transport unit 4600, 4700 respectively.

As illustrated, by configuring the inflatable portion 4634, 4734, the solid potion 4632, 4732 can be deployed to a desirable configuration. Referring to FIG. 46, a first side 4635 may be configured to extend away more than a second side 4636 of the inflatable portion 4634 with respect to the rear end 4620 of the transport unit 4600. This configuration can help put the solid portion 4632 in a tilted position relative to the rear end 4620 of the transport unit 4600.

Referring to FIG. 47, a first side 4735 may be configured to extend away about the same degree as a second side 4736 of the inflatable portion 4734 with respect to the rear end 4720 of the transport unit 4700. This configuration can help push the entire solid portion 4732 away from the rear end 4720.

In the illustrated embodiments of FIGS. 46 and 47, the solid portion 4632, 4732 is relatively flat. This is exemplary. It is appreciated that the solid portion 4632, 4732 can be configured to include other geometry features.

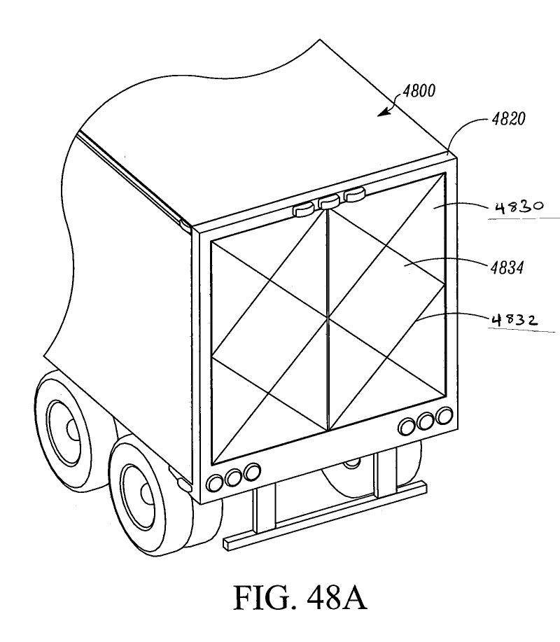

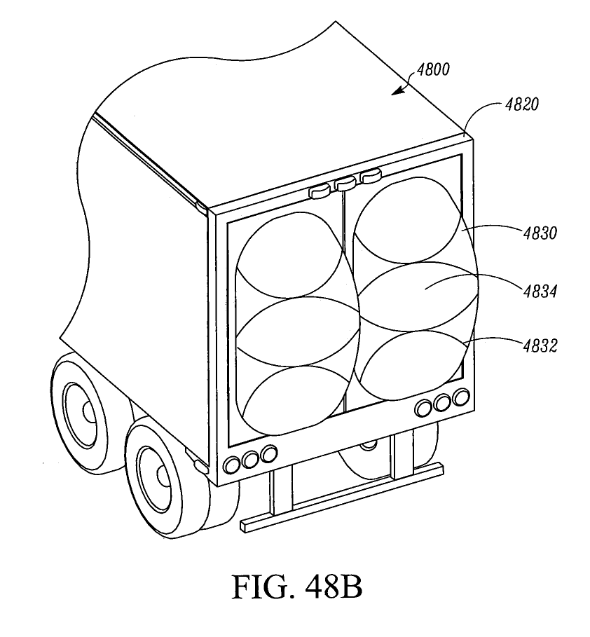

FIGS. 48A and 48B illustrate an aerodynamic tail 4830 in a non-inflated state and an inflated state respectively. The aerodynamic tail 4830 is generally attached to a rear end 4820 of a transport unit 4800, and includes an inflatable portion 4834 and a non-inflatable portion 4832.

The non-inflatable portion 4832 may include a foldable portion. When the inflatable portion 4834 is inflated in deployment, the non-inflatable portion 4832 can help shape the inflatable portion 4834. In some embodiments, the non-inflatable portion 4832 may include a folded state (e.g. the stage in FIG. 48A) and a deployed state. The deployment of the inflatable portion 4834 can help switch the non-inflatable portion 4832 from the folded state to the deployed state. In some embodiments, the non-inflatable portion 4832 may include, for example, a relatively flexible portion, such as a steel cable. In some embodiments, the non-inflatable portion 4832 may include an origami (e.g. foldable) structure.

The aerodynamic tail embodiments as disclosed herein may be stored in a rear end of a transport unit when in a folded state. For example, in some embodiments, the embodiments as disclosed herein may be stored in a structure attached to a rear door of the transport unit.

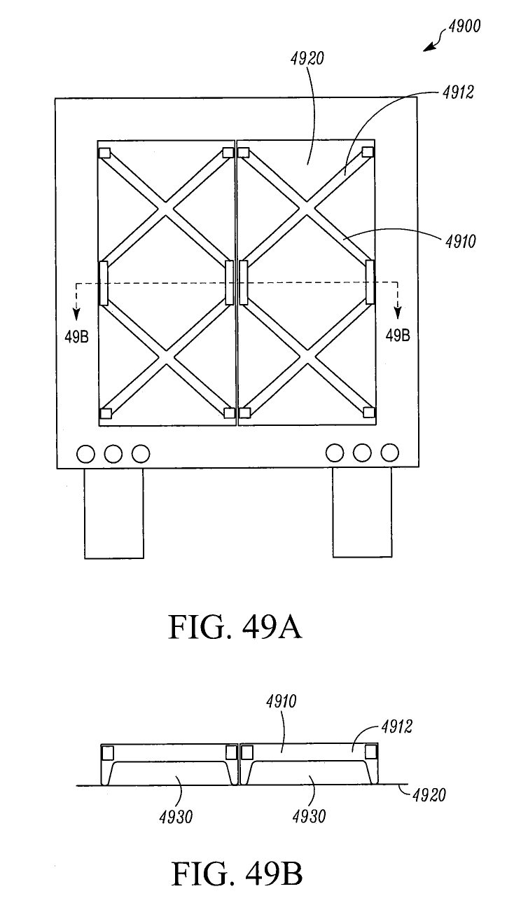

FIGS. 49A and 49B illustrate one storage structure 4910 that may be attached to a rear door 4920 of a transport unit 4900. As illustrated, the storage structure 4910 may include one or more holding member 4912 that is configured to hold the aerodynamic tails as disclosed herein in place.

FIG. 49B is a cross-section view of line 49B-49B in FIG. 49A. As illustrated, the storage structure 4910 may have a space 4930 between the holding member 4912 and the door 4920. The space 4930 may accommodate the aerodynamic tails as disclosed here in a folded state.

It is to be appreciated that the aerodynamic tails as disclosed herein can be made of various materials. In some embodiments, the aerodynamic tails as disclosed herein may include a spring steel material (e.g. the material of a tractable ruler). A structure made of the spring steel material can be deployed or retracted relatively easily.

In some embodiments, the aerodynamic tails described herein can be collapsed and housed into one or more of the rear doors of the transport unit. When the transport unit is part of a refrigerated transport unit, the rear doors can include super insulation in order to accommodate the aerodynamic tail.

In some embodiments, door panels of the rear doors can pop out and include a solid center with a perimeter formed of an elastic material (e.g., gortex, running cloth material, etc.). In some embodiments, the rear doors can include two pop out door panels on each door that can angle to meet at the center of the door. In some embodiments the aerodynamic tail can be shaped or designed to be completely flat on the rear door of the transport unit when folded. In some embodiments, the rear door can include a recessed area to store the aerodynamic tail. In some embodiments, the aerodynamic tail and/or the rear door can include perforations.

In some embodiments, the rear doors of the transport unit can include a seal between integrating flaps into the rear doors, the top of the rear doors and the bottom of the rear doors.

In some embodiments, the a top of the rear doors can include a lip to divert air upward, and/or an opening is provided at the top of the rear doors.

In some embodiments, a rolled material can be used to create the aerodynamic tail. The rolled material can be mounted on the rear doors at the top and/or the bottom. The rolled material can be deployed similar to an awning. In some embodiments, the rolled material can slide up into a slot similar to a garage door.

It is to be appreciated that embodiments as disclosed herein may be made as a retrofit kit to modify existing components of a tractor trailer and transport unit.

It will be appreciated that control systems, control implementations, schemes, and the like can be suitably applied to the aerodynamic tail implementations described herein, and may for example incorporate concepts discussed with respect to Part IV below.

### Part IV: Control

A transport unit, as described with respect to Part IV, generally refers to an apparatus or system that can be used to transport a cargo, e.g. a truck, a trailer, a container, a train, an airplane, or a ship. In some transport units that may move in a relatively high speed (e.g. 60 mph or above), such as a truck or a trailer, movements of the transport units may result in increased aerodynamic resistance (e.g. aerodynamic drag) and decreased fuel efficiency. It is desirable to reduce the aerodynamic resistance when the transport unit is in motion.

Aerodynamic and/or accessory devices of a transport unit can trigger law enforcement fines in some locations if not stowed correctly during vehicle operation. The position of these devices can be difficult to monitor during operation as they can have many moving parts and may not be visible to a driver. The embodiments described herein are directed to a method and system for detecting, communicating and controlling the status of an aerodynamic or accessory device of a transport unit.

References are made to the accompanying drawings that form a part hereof, and in which is shown by way of illustration of the embodiments in which the embodiments may be practiced. It is to be understood that the terms used herein are for the purpose of describing the figures and embodiments and should not be regarded as limiting the scope.

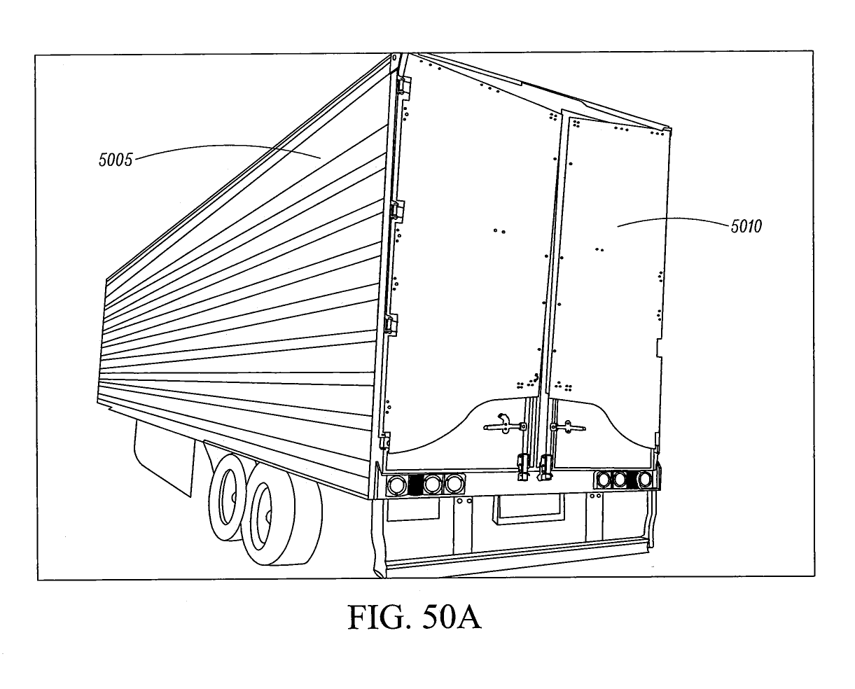

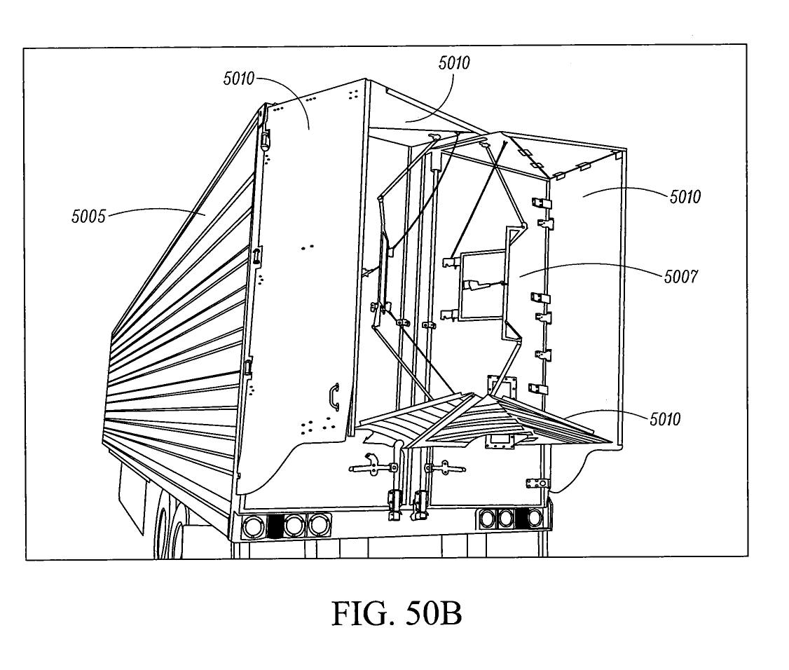

Referring to FIGS. 50A and 50B, a transport unit 5005 is provided with a trailer tail 5010 in a closed position (FIG. 1A) and in an open position (FIG. 1B). When the trailer tail 5010 is in an open position, the trailer tail 5010 can reduce or eliminate a relatively low pressure region near the rear of the transport unit 5005 and can help reduce aerodynamic drag, resulting in increased fuel efficiency.

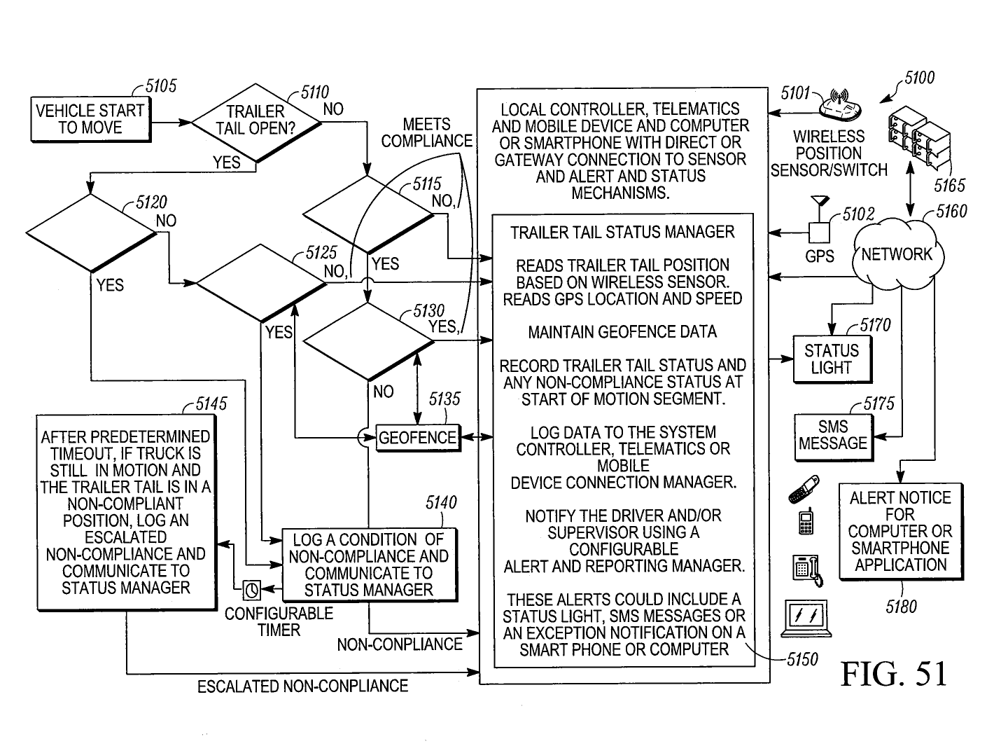

FIG. 51 illustrates a method and system 5100 of detecting, communicating and controlling the status of a trailer tail, according to one embodiment. The system 5100 includes a wireless sensor/switch 5101 attached to the trailer tail that is configured to monitor an open or closed position of the trailer tail, a GPS 5102 configured to determine a location of the transport unit, a controller 5150 configured to receive data from the wireless sensor/switch 5101 and the GPS 5102. The controller 5150 is connected via a network 5160 to a remote host system 5165, a driver status light 5170, a third party device 5175, 5180 (e.g., a smart phone, computer, tablet, etc.). The controller is also connected to the driver status light 5170 via a wired or local wireless connection (e.g., Bluetooth, ZigBee, WiFi, Infrared, etc.). The controller 5150 is configured to communicate with the wireless sensor switch 5101 via a wireless connection (e.g., Bluetooth, ZigBee, WiFi, Infrared, etc.).

The controller 5150 can be, for example, a local system controller (e.g., a transport refrigeration system controller), a telematics unit, a mobile device, a computer or smartphone with a direct or gateway connection to sensors and alert and status mechanisms of the transport unit.

At 5105, the controller 5150 determines that a vehicle towing the transport unit is moving. At 5110, the controller communicates with the wireless sensor/switch 5101 to determine whether the trailer tail is open. If the trailer tail is open, the method proceeds to 5120. If the trailer tail is not open, the method proceeds to 5115.

At 5115, the controller 5150 communicates with the GPS 5102 to determine the location of the transport unit. Based on the location of the transport unit, the controller 5150 determines whether the transport unit is currently located in a trailer tail non-regulated location. If the transport unit is located in a trailer tail non-regulated location, the method proceeds to 5130. If not, the controller 5150 determines that the trailer tail is located in a trailer tail regulated location, meets compliance for the trailer tail regulated location and the method ends.

At 5130, the controller 5150 determines whether the transport unit is approaching a trailer tail regulated location. If the transport unit is approaching a trailer tail regulated location, the controller 5150 proceeds to 5140. If not, the controller 5150 determines that the trailer tail is located in a trailer tail regulated location, meets compliance for the trailer tail regulated location and the method ends.

At 5140, the controller 5150 determines that the transport unit could be approaching or is in a trailer tail regulated location and can log the condition in a data logger and/or communicate the appropriate status to the driver via, for example, the status light 4170, a SMS message to the third party device 5175, an alert notice for a computer or smartphone application to the third party device 5180. The method then starts a configurable timer and proceeds to 5145.

At 5145, after the predetermined timer has elapsed, the controller 5150 determines whether the transport unit is still in transport, if the trailer tail is in a non-compliant position and if so, logs an escalated non-compliance condition to be communicated via the status light 5170 or via the third party device 5175, 5180.

At 5120, the controller 5150 communicates with the GPS 5102 to determine the location of the transport unit. Based on the location of the transport unit, the controller 5150 determines whether the transport unit is currently located in a trailer tail regulated location. If the transport unit is currently located in a trailer tail regulated location, the method proceeds to 5140. If not, the method proceeds to 5125.

At 5125, the controller 5150 determines whether the transport unit is approaching a trailer tail regulated location. If the transport unit is approaching a trailer tail regulated location, the controller 5150 proceeds to 5140. If not, the controller 5150 determines that the trailer tail is located in a non-trailer tail regulated location, meets compliance, and the method ends.

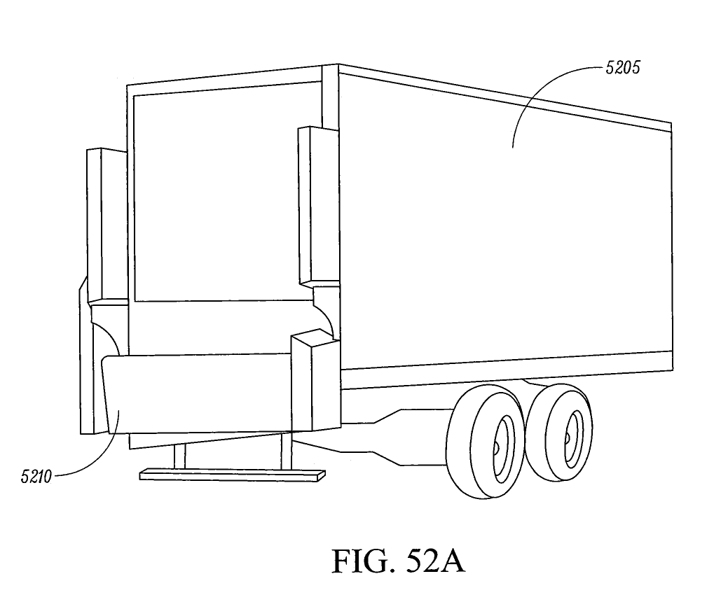

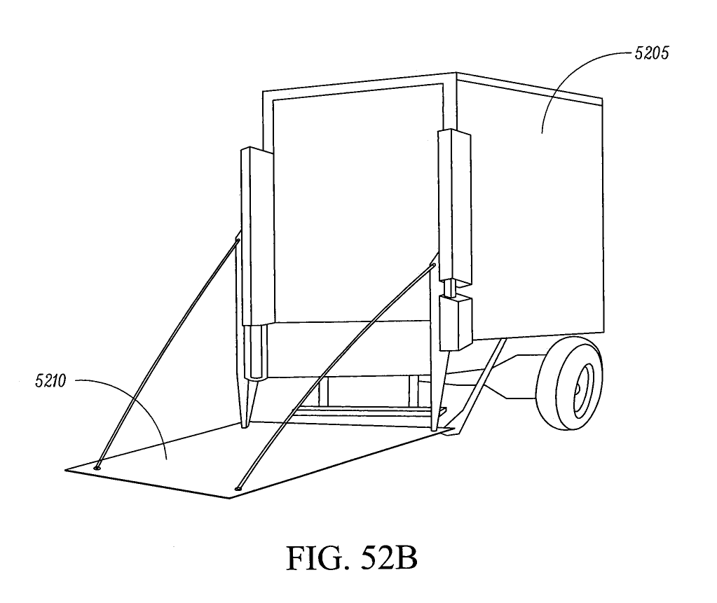

Referring to FIGS. 52A and 52B, the transport unit 5205 is provided with a lift gate 5210 in a closed position (FIG. 3A) and in an open position (FIG. 3B).

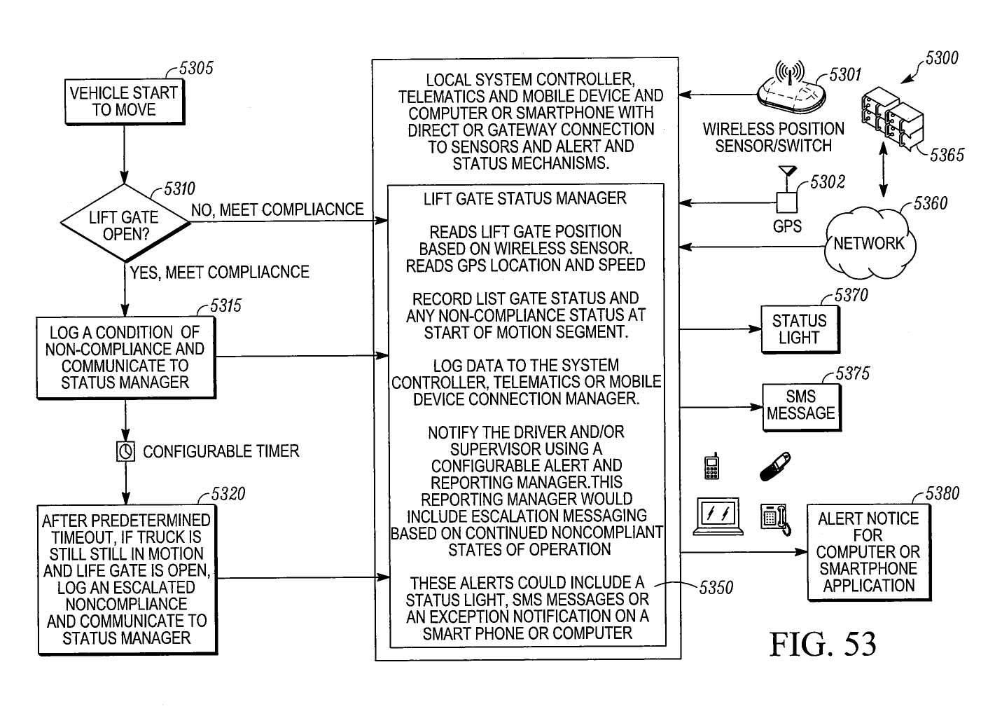

FIG. 53 illustrates a method and system 5300 of detecting, communicating and controlling the status of a lift gate, according to one embodiment. The system 5300 is similar to the system 5100 shown in FIG. 51 and includes the wireless sensor/switch 5301 attached to the lift gate that is configured to monitor an open or closed position of the lift gate, the GPS 5302 configured to determine a location of the transport unit, the controller 5350 configured to receive data from the wireless sensor/switch 5301 and the GPS 5302. The controller 5350 is connected via a network 5360 to a remote host system 5365, a driver status light 5370, a third party device 5375, 5380 (e.g., a smart phone, computer, tablet, etc.). The controller is also connected to the driver status light 5370 via a wired or local wireless connection (e.g., Bluetooth, ZigBee, WiFi, Infrared, etc.). The controller 5350 is configured to communicate with the wireless sensor switch 5301 via a wireless connection (e.g., Bluetooth, ZigBee, WiFi, Infrared, etc.).

The controller 5350 can be, for example, a local system controller (e.g., a transport refrigeration system controller), a telematics unit, a mobile device, a computer or smartphone with a direct or gateway connection to sensors and alert and status mechanisms of the transport unit.

At 4305, the controller 5350 determines that a vehicle towing the transport unit is moving. At 5310, the controller communicates with the wireless sensor/switch 5301 to determine whether the lift gate is open. If the lift gate is open, the method proceeds to 415. If the lift gate is not open, the controller 5350 determines that the lift gate position is in a compliant position and the method ends.

At 5315, the controller 5350 determines that the lift gate is in a non-compliant position and can log the condition in a data logger and/or communicate the appropriate status to the driver via, for example, the status light 5370, a SMS message to the third party device 5375, an alert notice for a computer or smartphone application to the third party device 5380. The method then starts a configurable timer and proceeds to 5320.

At 5320, after the predetermined timer has elapsed, the controller 5350 determines whether the transport unit is still in transport, if the lift gate is in a non-compliant position and if so, logs an escalated non-compliance condition to be communicated via the status light 5370 or via the third party device 5375, 5380.

It will be appreciated that the embodiments described herein can be implemented in other transport unit aerodynamic and/or accessory devices. In some embodiments, a controller can be configured to change a position (e.g., open and/or close) the one or more transport unit aerodynamic and/or accessory devices. Also, in some embodiments, the controller can communicate with a pressure sensor that monitors a pressure at a rear end of the transport unit and with a speed sensor that monitors a speed of the transport unit. The controller can be configured to control a position of the one or more transport unit aerodynamic and/or accessory devices based on one or more of the pressure data obtained from the pressure sensor and/or speed data obtained from the speed sensor. The controller can also be configured to provide a visual indicator to the driver's dashboard that the transport unit aerodynamic and/or accessory device has changed in position.

For example, in one embodiment, the controller can be configured to retract or expand a transport unit aerodynamic and/or accessory device (e.g., aerodynamic wings) based on a pressure reading and/or speed reading and provide a visual indicator (e.g., status light) to a driver's dashboard. In another example, the controller can be configured to adjust an angle and position of a trailer tail based on negative pressure readings at a rear end of the transport unit and/or speed. In some embodiments, the trailer tail can have a plane flap design in which air pressure at the rear of the transport unit can be configured to raise or lower the trailer tail while the transport unit is in transport.

It will be appreciated that the embodiments described herein can be applied with, for example, aerodynamic tails, airflow directors, etc. discussed in Parts I-III above.

With regard to the foregoing description described in Parts I-IV, it is to be understood that changes may be made in detail, without departing from the scope of the present invention. It is intended that the specification and depicted embodiments are to be considered exemplary only, with a true scope and spirit of the invention being indicated by the broad meaning of the claims. It is to be understood that the terms used herein are for the purpose of describing the figures and embodiments and should not be regarded as limiting the scope.

1. A transport unit, comprising:
a body having a front wall, a rear wall, a top wall and a bottom wall;
a structure provided on the body configured to reduce pressure differential of relatively high pressure areas external to the transport unit as compared to relatively low pressure areas rearward of the rear wall;
wherein the structure is configured to improve energy efficiency, counter turbulent airflows, and/or reduce drag of the transport unit.

2. The transport unit of claim 1, wherein the structure is one or more channels extending along the body of the transport unit.

3. The transport unit of claim 2, wherein a channel of the one or more channels comprises an end structure, the end structure including one or more of a scoop, a baffle, an ejector.

4. The transport unit of claim 1, wherein the structure comprises one or more angled structures with respect to the walls of the body.

5. The transport unit of claim 4, wherein the angled structures include a deployed and a non-deployed position.

6. The transport unit of claim 1, wherein the structure comprises a mechanism to generate relatively high pressure air rearward of the rear wall.

7. The transport unit of claim 6, wherein the mechanism includes one or more of: an air source in fluid communication with the relatively low pressure areas rearward of the rear wall; a heating element; a fan; a deflector toward a bottom of the bottom wall; a drag deflector with vanes; one or more plates with apertures; and a turbulating structure that protrudes from a rear wall of the body.

8. The transport unit of claim 1, wherein a transport refrigeration unit (TRU) is provided at the front wall of the body.

9. A tractor and transport unit combination comprising:
a tractor;
a transport unit attachable to the tractor, the transport unit defined by a front wall, a rear wall, a top wall and a bottom wall;
a structure configured to reduce pressure differential of relatively high pressure areas external to the transport unit as compared to relatively low pressure areas rearward of the rear wall;
wherein the structure is configured to improve energy efficiency, counter turbulent airflows, and/or reduce drag of the tractor.

10. The tractor and transport unit combination of claim 9, wherein the structure is a fairing configured to cover a gap between the tractor and the transport unit.

11. The tractor and transport unit combination of claim 10, wherein the fairing includes a passage having a first opening facing a front side of the tractor and a second opening facing the gap, wherein the passage is configured to receive high pressure air via the first opening during transport and direct the high pressure air through the second opening into the gap.

12. The tractor and transport unit combination of claim 11, wherein the passage is formed of a material that is configured to inflate when the tractor and transport unit combination are in transport.

13. The tractor and transport unit combination of claim 11, wherein the structure includes a force-loaded device configured to open the passage based on at least one of: an air pressure of air passing through the passage, and an actuator controlled by a controller.

14. The tractor and transport unit combination of claim 9, wherein the structure is an aerodynamic tail provided at a rear wall of the transport unit, the aerodynamic tail configured to direct air toward the rear wall of the transport unit.

15. The tractor and transport unit combination of claim 14, wherein the aerodynamic tail includes a parachute structure configured to be in a folded state when the tractor and transport unit combination are not in motion and configured to be in a deployed state when the tractor and transport unit combination are in motion.

16. The tractor and transport unit combination of claim 15, wherein the aerodynamic tail includes an attachment link connecting the rear wall to the parachute structure.

17. The tractor and transport unit combination of claim 15, wherein the parachute structure has a conical shape that includes a first opening at a peak of the parachute structure and facing the rear wall, and a second opening facing away from the rear wall.

18. The tractor and transport unit combination of claim 14, wherein the aerodynamic tail includes a windsock structure having a hollow channel configured to direct airflow therethrough.

19. The tractor and transport unit combination of claim 14, wherein the aerodynamic tail includes an inflatable portion having an inflated state and a deflated state.

20. The tractor and transport unit combination of claim 19, wherein the aerodynamic tail includes a member configured to shape the inflatable portion when the inflated portion is in the inflated state.
